(19) United States
(12) Patent Application Publication
(10) Pub. No.: US 2025/0324163 A1
(43) Pub. Date: Oct. 16, 2025

(54) COLOR CONSISTENT AND SHADOWLESS IMAGES FROM STROBE ONLY ILLUMINATION

(71) Applicant: Apple Inc., Cupertino, CA (US)

(72) Inventors: Yuko Roodt, Cambridge (GB); Tobias Baldauf, Newmarket (GB); Jason P. de Villiers, Cambridge (GB); Bradley D. Ford, San Jose, CA (US); James C. Kent, Cupertino, CA (US); Thomas F. Outlaw, London (GB); Thilaka S. Sumanaweera, San Jose, CA (US); Gopal Valsan, Gilroy, CA (US); Julio C. Hernandez Zarazoga, Cupertino, CA (US)

(21) Appl. No.: 18/634,418

(22) Filed: Apr. 12, 2024

(51) Int. Cl. H04N 23/74; G06T 5/50; G06T 5/60; H04N 23/71; H04N 23/84

(52) U.S. Cl. CPC H04N 23/74; G06T 5/50; H04N 23/71; H04N 23/84; G06T 5/60; G06T 2207/20016; G06T 2207/20221

(57) ABSTRACT

The present technology addresses the need for color-consistent photos and videos by comparing a frame captured under ambient lighting and a frame captured using flash lighting to adjust the frame to appear as if the ambient lighting were substantially removed. Since the ambient lighting is the source of the inconsistent appearance of color, processing the frame to appear as if it were presented under consistent lighting conditions yields a color-consistent frame that can be more useful in the medical context or other contexts where consistent color is more important than ambiance created from ambient lighting. The present technology can also address unwanted shadows as well. Since the present technology adjusts the frame to appear as if the ambient lighting were substantially removed, the source of the lighting causing the shadows is also removed.

### BACKGROUND

Achieving consistent color representation in photos taken under various lighting conditions is a challenging aspect of digital photography. This inconsistency arises because different light sources have varying color temperatures, influencing how colors are rendered in an image. Natural light, such as sunlight, changes in color temperature throughout the day. Artificial light sources, such as tungsten or fluorescent lights, add further variation by introducing their own color casts. Images taken under different lighting conditions can exhibit varied color tones, making it difficult to achieve a consistent look across photos.

Shadows appearing in photos due to the mobile phone capturing the photo is another common issue encountered in digital photography. When external lighting is positioned at certain angles relative to the device, the body of the phone or the user's hand holding the device can obstruct light, resulting in unwanted shadows appearing in the captured image. Such shadows can detract from the quality of the photograph, as they might obscure details or create an unintended mood or atmosphere.

### BRIEF DESCRIPTION OF THE SEVERAL VIEWS OF THE DRAWINGS

Details of one or more embodiments of the subject matter described in this disclosure are set forth in the accompanying drawings and the description below. However, the accompanying drawings illustrate only some typical embodiments of this disclosure and are therefore not to be considered limiting of its scope. Other features, embodiments, and advantages will become apparent from the description, the drawings and the claims.

FIG. 1A, and FIG. 1B collectively illustrates an example method for generating a color-consistent frame in accordance with some embodiments of the present technology.

FIG. 2 illustrates an example schematic process showing some steps for the creation of a color-consistent frame in accordance with some embodiments of the present technology.

FIG. 3 illustrates an example routine for predicting whether at least one of the aligned features subject to matt haze or weak clipping in the frame captured using flash lighting in accordance with some embodiments of the present technology.

FIG. 4 illustrates an example method for transferring clipped portions of a frame captured under ambient lighting into a frame captured using flash lighting in accordance with some embodiments of the present technology.

FIG. 5 illustrates an example schematic illustration of a clipping recovery process in accordance with some embodiments of the present technology.

FIG. 6 illustrates an example method for outputting a visual confidence map in accordance with some embodiments of the present technology.

FIG. 7A and FIG. 7B illustrates examples of a visual confidence map in accordance with some embodiments of the present technology.

FIG. 8 illustrates an example of a frame captured under ambient lighting and a color-consistent frame without shadows in accordance with some embodiments of the present technology.

FIG. 9 illustrates an example of a frame captured under ambient lighting and a color-consistent frame with clipping recovery in accordance with some embodiments of the present technology.

FIG. 10 is a system diagram illustrating a device in accordance with some embodiments of the present technology.

FIG. 11 is a system diagram illustrating image processing pipelines implemented using an image signal processor in accordance with some embodiments of the present technology.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Achieving consistent color representation in photos taken under various lighting conditions is a challenging aspect of digital photography. This inconsistency arises because different light sources have different spectral characteristics-including but not limited to correlated color temperature (CCT) and tint-influencing how colors are rendered in an image. It should be understood that any reference to color temperature of a light source also refers to other spectral properties too. Natural light, such as sunlight, changes in color temperature throughout the day. Artificial light sources, such as tungsten or fluorescent lights, add further variation by introducing their own color casts. Images taken under different lighting conditions can exhibit varied color tones, making it difficult to achieve a consistent look across photos.

In many cases, the inconsistency in colors due to different lighting conditions does not pose a problem. Humans are adept at interpreting photos taken under different lighting conditions and can still get value from photos taken under diverse lighting conditions. However, there are instances where color inconsistency is problematic.

For example, in health settings, color consistency is important. If a patient were to take a photo or engage in a telehealth appointment via video conferencing, a care provider might not be able to effectively diagnose a skin condition if lighting conditions make the skin condition look less pronounced or more pronounced than it actually is.

The present technology addresses the need for color-consistent photos and videos by comparing a frame captured under ambient lighting and a frame captured using flash lighting with known spectral characteristics to adjust the frame to appear as if the ambient lighting were substantially removed. Since the ambient lighting is the source of the inconsistent appearance of color, processing the frame to appear as if it were presented under consistent lighting conditions yields a color-consistent frame that can be more useful in the medical context or other contexts where consistent color is more important than ambiance created from ambient lighting.

Shadows appearing in photos due to the mobile phone capturing the photo is another common issue encountered in digital photography. When a source of ambient lighting is positioned at certain angles relative to the device, the body of the phone or the user's hand holding the device can obstruct light, resulting in unwanted shadows appearing in the captured image. Such shadows can detract from the quality of the photograph, as they might obscure details or create an unintended mood or atmosphere.

The present technology can also address unwanted shadows as well. Since the present technology adjusts the frame to appear as if the ambient lighting were substantially removed, the source of the lighting causing the shadows is also removed. The resulting frame appears as if the strobe associated with the camera is the primary source of light, which has a result of providing a frame without shadows.

As described above, one embodiment of the present technology is the gathering and use of data available from photos or videos. The present disclosure recognizes that the collection of such personal information data, in the present technology, can be used to the benefit of users. For instance, images may be sources of health and fitness data that can be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

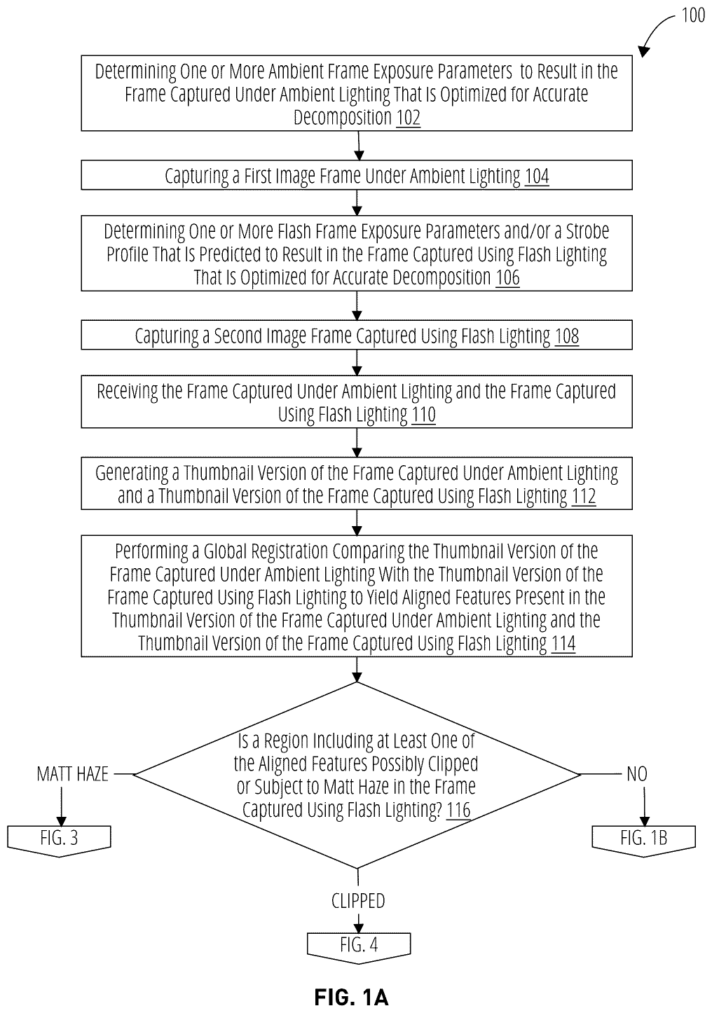

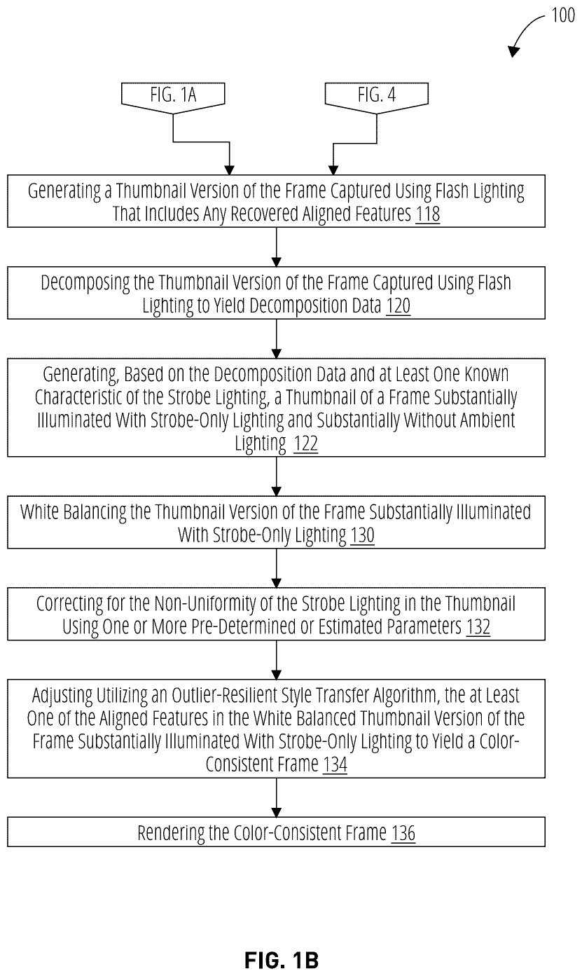

FIG. 1A and FIG. 1B collectively illustrates an example color-consistent frame generation process 100 for generating a color-consistent frame in accordance with some embodiments of the present technology. Although the example method depicts a particular sequence of operations, the sequence may be altered without departing from the scope of the present disclosure. For example, some of the operations depicted may be performed in parallel or in a different sequence that does not materially affect the function of the method. In other examples, different components of an example device or system that implements the method may perform functions at substantially the same time or in a specific sequence.

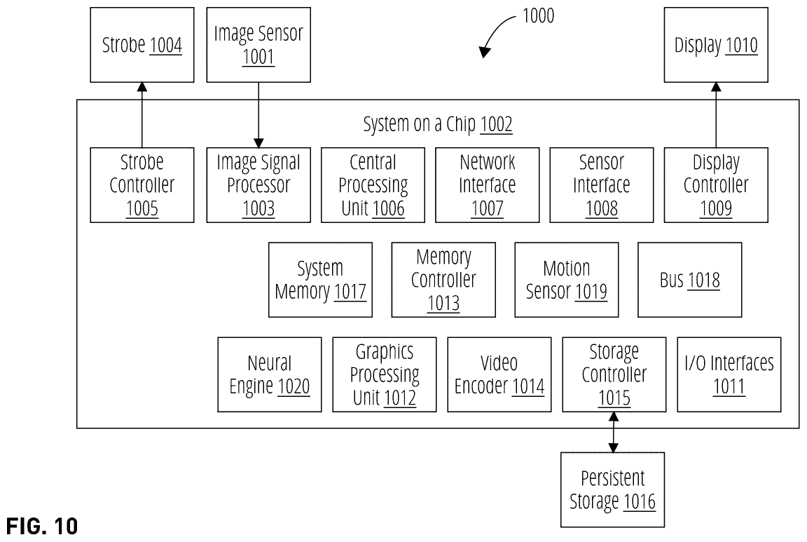

FIG. 1A and FIG. 1B is described in the context of functions performed by processing units such as image signal processor 1003, central processing unit 1006, graphics processing unit 1012, and/or neural engine 1020 illustrated in FIG. 10. Although functions are described as being performed by one of these processing units, it will be appreciated by those of ordinary skill that many of these functions can be performed by other processing units or combinations of processing units, and the functions might be performed in coordination with other components of device 1000 illustrated in FIG. 10. The specific mention of a specific processing unit should not be considered limiting and the inventors explicitly contemplate that any of the described functions can be performed by any of the processing units.

As introduced above, in many cases, the inconsistency in colors due to different lighting conditions does not pose a problem because humans are adept at interpreting photos taken in different lighting conditions. However, there are instances where this color inconsistency is problematic. For example, in health settings, color consistency is important. If a patient were to take a photo or engage in a telehealth appointment via video conferencing, a care provider might not be able to effectively diagnose a skin condition if lighting conditions make the skin condition look less pronounced or more pronounced than it actually is.

The present technology addresses the need for color-consistent photos and videos by comparing a frame captured under ambient lighting and a frame captured using flash lighting to adjust the frame to appear as if the ambient lighting were substantially removed. The frame captured using flash lighting is frame capturing a scene illuminated by both ambient lighting and strobe lighting. Since the ambient lighting is the source of the inconsistent appearance of color, processing the frame to appear as if it were presented under consistent lighting conditions yields a color-consistent frame that can be more useful in the telehealth context or other contexts where consistent color is more important than ambiance created from ambient lighting.

According to some examples, the method includes determining, by an auto exposure algorithm, one or more ambient frame exposure parameters to result in the frame captured under ambient lighting that is optimized for accurate decomposition at block 102. For example, the image signal processor 1003 illustrated in FIG. 10 may determine, using an auto exposure algorithm, one or more ambient frame exposure parameters to result in the frame captured under ambient lighting that is optimized for accurate decomposition. In many instances, the ambient frame exposure parameters will be the same parameters provided to capture a quality image. But in some instances, the ambient frame exposure parameters might be chosen to result in a slightly under-exposed image to provide for a greater range in deviation from data derived from the frame captured under ambient lighting as compared to the frame captured using flash lighting in subsequent steps.

According to some examples, the method includes capturing a first image frame under ambient lighting to yield a frame captured under ambient lighting at block 104. For example, the image sensor 1001 illustrated in FIG. 10 may capture a first image frame under ambient lighting to yield a frame captured under ambient lighting. In some embodiments, the frame captured under ambient lighting can be more than one frame. While FIG. 1A shows the one or more frames captured under ambient lighting are captured before frames captured using flash lighting, this is not a requirement, and the frames captured under ambient lighting could occur after capturing one or more frames captured using flash lighting, or the frames could be captured in alternating orders (ambient, flash, ambient, flash), or any order.

According to some examples, the method includes determining one or more strobe frame exposure parameters and/or a strobe profile that is predicted to result in the frame captured using flash lighting that is optimized for accurate decomposition at block 106. For example, the image signal processor 1003 illustrated in FIG. 10 may determine, by an auto exposure algorithm, one or more strobe frame exposure parameters and/or a strobe profile that is predicted to result in the frame captured using flash lighting that is optimized for accurate decomposition. The strobe frame exposure parameters are those pertaining to image capture, while the strobe profile pertains to adjustable aspects of the strobe. The auto-exposure algorithm can attempt to optimize the frame captured using flash lighting to have as much difference from the frame captured under ambient lighting as possible while reducing portions of the frame captured using flash lighting that are overexposed.

Some attributes of the strobe profile that can be adjusted include a strobe duration, a strobe strength, strobe spectrum, and an angular profile. For example, some strobe devices can include strobes with adjustable intensities, and some strobe devices include multiple strobes, maybe with different emission spectra that can be activated independently to control an angular profile or spectrum of the light emitted from the strobe. An angular profile refers to the pattern and spread of light emitted from the strobe unit as it disperses over an area, as well as how this dispersion changes at different angles relative to the strobe. This can include how the intensity and distribution of light vary as one moves away from the central axis of the strobe, which is directly in front of it, towards the sides.

In some embodiments, depth value details and strobe properties can also be used to estimate the reflectivity/albedo/skin tone of surfaces in the scene. The known albedo of surfaces in the scene can be used to compute a more optimal strobe duration, strength, and angular profile. The depth can be determined from stereo images, a LiDAR sensor, a focus pixel, comparing multiple frames captured using strobe lighting and multiple frames captured under ambient lighting to observe motion, machine learning algorithms for estimating depth, etc.

According to some examples, the method includes capturing a second image frame captured using flash lighting at block 108. For example, the image sensor 1001 illustrated in FIG. 10 may capture a frame captured using flash lighting. A frame captured using flash lighting refers to a frame capturing a scene illuminated by ambient lighting and strobe lighting. If the auto exposure algorithm provided strobe frame exposure parameters the strobe lighting can be consistent with those parameters. While FIG. 1A shows that one or more frames captured using flash lighting are captured after frames captured under ambient lighting, this is not a requirement, and the frames captured under ambient lighting could occur after capturing one or more frames captured using flash lighting, or the frames could be captured in alternating orders (ambient, flash, ambient, flash), or any order.

According to some examples, the method includes receiving the frame captured under ambient lighting and the frame captured using flash lighting at block 110. For example, the image signal processor 1003 illustrated in FIG. 10 may receive the frame captured under ambient lighting and the frame captured using flash lighting.

According to some examples, the method includes generating a thumbnail version of the frame captured under ambient lighting and a thumbnail version of the frame captured using flash lighting at block 112. For example, the image signal processor 1003 illustrated in FIG. 10 may generate a thumbnail version of the frame captured under ambient lighting and a thumbnail version of the frame captured using flash lighting. In some embodiments, the thumbnail versions can be 512×384 pixel thumbnails of a higher resolution image (1K, 2K, 4K, 8K, 16K, 24K, 32K, 48K, etc.) although any resolution thumbnail or original image can be used. In some embodiments, the thumbnail version thumbnail is of a resolution which is less than or equal to the full resolution image. As will be addressed further herein, working on a lower-resolution thumbnail reduces processing resources and memory resources that are required and can make some steps, such as the global registration, next more resilient to discrepancies between the frames.

According to some examples, the method includes performing a global registration comparing the thumbnail version of the frame captured under ambient lighting with the thumbnail version of the frame captured using flash lighting to yield aligned features present in the thumbnail version of the frame captured under ambient lighting and the thumbnail version of the frame captured using flash lighting at block 114. For example, the image signal processor 1003 illustrated in FIG. 10 may perform a global registration comparing the thumbnail version of the frame captured under ambient lighting with the thumbnail version of the frame captured using flash lighting to yield aligned features present in the thumbnail version of the frame captured under ambient lighting and the thumbnail version of the frame captured using flash lighting.

In the context of a global registration of frames, aligned features refer to matching or corresponding points, edges, shapes, or other identifiable characteristics across multiple frames (such as the frame captured under ambient lighting and the frame captured using flash lighting) that have a coherent spatial arrangement. The global registration could be informed by inertial measurements, including those taken by accelerometers, gyros, and magnetometers. Aligned features can refer to local regions in the frames, can refer to objects within the frames, or points, edges, shapes, or other identifiable characteristics of those objects. The aligned features can also refer to pixels or local groupings of pixels. There can be many aligned features present in the frames, where the different aligned features can be processed differently depending on their specific features. For example, some aligned features might only need to be processed to adjust the color so that the at least one of the aligned features appears as if it were illuminated substantially with strobe-only lighting, while some of the at least one of the aligned features might need to be processed to transfer detail from the frame captured under ambient lighting as is addressed further herein.

The global registration reduces errors caused by pixel-level registration and has reduced processing requirements. Further, performing the global registration on thumbnails as opposed to the full-resolution frames also makes the global registration less susceptible to errors.

In addition to the global registration, the process can also perform local registrations in addition to or in an alternate of the global registration.

According to some examples, the method includes determining whether a region including at least one of the aligned features is possibly clipped or subject to matt haze in the frame captured using flash lighting at decision block 116. For example, at decision block 116 the central processing unit 1006 can detect that a region including at least one of the aligned features includes a proportion of pixels above a threshold brightness range, which indicates that the aligned features may be clipped or subject to matt haze. When the proportion of the pixels is above an upper threshold the aligned features are considered to be clipped, and when the proportion of the pixels is above a threshold brightness range but less than the upper threshold proportion of the pixels the aligned features may be subject to matt haze. When a region including at least one of the aligned features does not include a proportion of pixels above the threshold brightness range, the aligned features are not clipped nor subject to matt haze.

“Clipped” refers to a condition where the intensity of the light from the strobe exceeds the dynamic range of the camera sensor in one or more color channels resulting in areas of the photograph that are overexposed to the point of losing significant detail. “Matt haze” refers to a non-uniform reflection effect that scatters light, causing pixels making up at least one of the aligned features to be above a valid brightness range.

When at decision block 116 it is determined that the aligned features are not clipped nor subject to matt haze the method can continue without further processing to block 120.

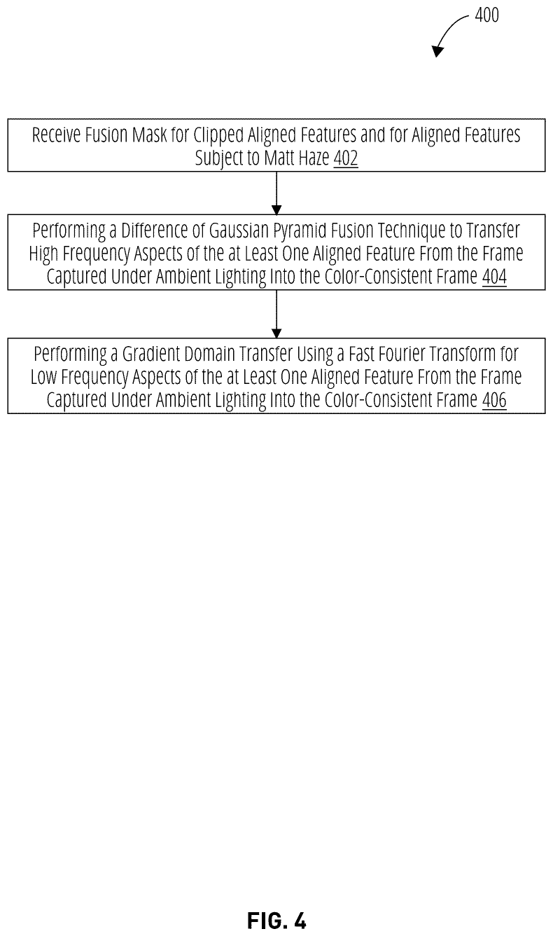

When it is determined at decision block 116 that the aligned features are clipped, the method proceeds to a detail transfer process addressed in FIG. 4. Briefly, FIG. 4 can receive a clipping mask that identifies aligned features for which detail should be transferred from the frame captured under ambient lighting into the frame captured using flash lighting.

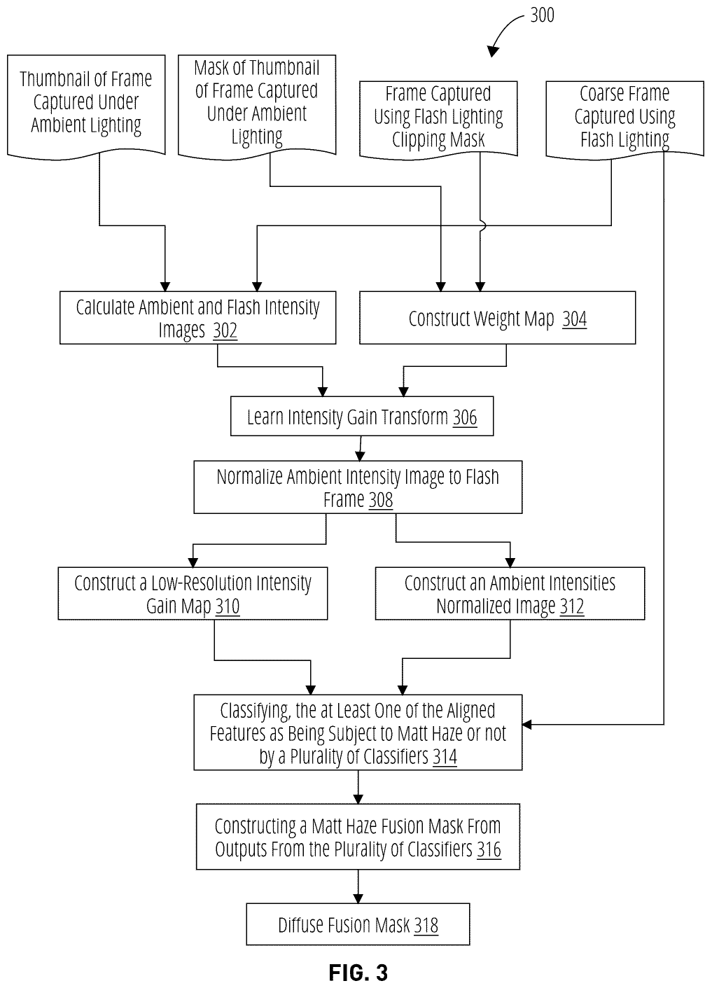

When it is determined at decision block 116 that the aligned features are subject to matt haze, the method proceeds to a matt haze mask creation process addressed in FIG. 3 to further discern whether the aligned features are really subject to matt haze and to create a mask to identify aligned features for which detail should be transferred from the frame captured under ambient lighting into the frame captured using flash lighting.

It should be noted that all three outcomes of decision block 116 can occur on the same frame captured using flash lighting. Some aligned features might be clearly clipped, some aligned features might be subject to matt haze, and most aligned features will likely not require any detail recovery from the detail transfer process in FIG. 4. The most likely outcomes are that none of the aligned features will need detail recovery, or that a minority of the aligned features will need some detail recovery from the frame captured under ambient lighting.

Since there will be multiple aligned features, it is possible that some of the aligned features are subject to clipping or matt haze, while other features will not have these issues. As such, the method will treat respective aligned features accordingly. Therefore, it should be appreciated that portions of the methods addressed herein can be performed in parallel for the respective aligned features.

After any details of at least one of the aligned features that need to be recovered from the frame captured under ambient lighting have been transferred using the detail transfer process of FIG. 4, the method returns to block 118.

According to some examples, the method includes generating a thumbnail version of the frame captured using flash lighting that includes any recovered aligned features (from FIG. 4) at block 118. For example, the image signal processor 1003 illustrated in FIG. 10 may generate a thumbnail version of the frame captured using flash lighting that includes any recovered aligned features. In some embodiments, the thumbnail versions can be 512×384 pixel thumbnails of a higher resolution image (1K, 2K, 4K, 8K, 16K, 24K, 32K, 48K, etc.) although any resolution thumbnail or original image can be used. In some embodiments, the thumbnail version thumbnail is of a resolution which is less than or equal to the full resolution image. As will be addressed further herein, working on a lower-resolution thumbnail reduces processing resources and memory resources that are required and can make some steps be more resilient to local errors.

According to some examples, the method includes decomposing the thumbnail version of the frame captured using flash lighting that includes any recovered aligned features to yield decomposition data at block 120. For example, the image signal processor 1003 illustrated in FIG. 10 may decompose the thumbnail version of the frame captured using flash lighting that includes any recovered aligned features to yield decomposition data. The decomposition of an image frame refers to the process of breaking down a single image into its constituent parts or layers for analysis, processing, or manipulation. Decomposition can be achieved through several methods, each focusing on different aspects of the image. For example, color decomposition can separate the image into its primary color components (such as Red, Green, and Blue channels in RGB images) or other color spaces (like YCbCr or HSV) to facilitate color-based processing or adjustments. Spatial decomposition can divide the image into segments or regions based on spatial relationships or features. This can be used in object detection, segmentation, and region-based processing. Frequency decomposition can transform the image from the spatial domain to the frequency domain using mathematical transforms (e.g., Fourier Transform or Wavelet Transform). This allows for manipulation of certain frequencies to achieve effects like smoothing, sharpening, or compression. Layer decomposition can separate an image into layers based on content, such as foreground and background layers, to allow for independent editing of different parts of the image.

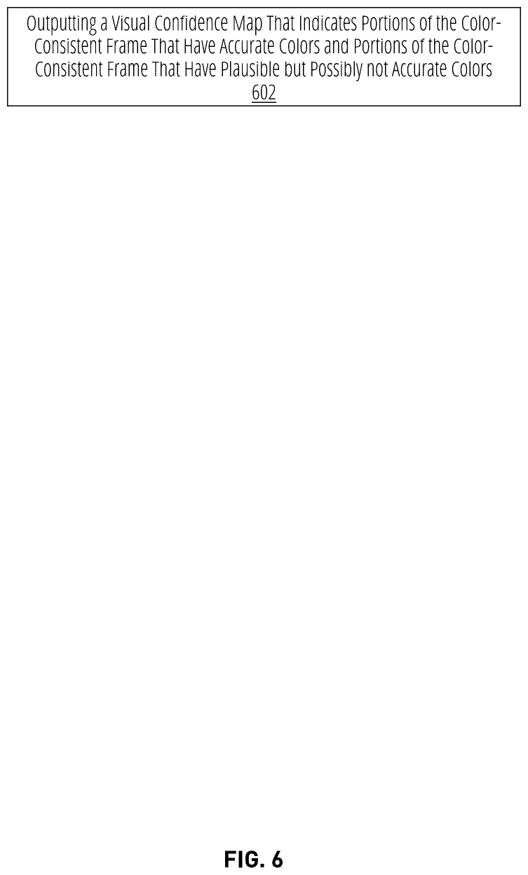

Since the clipping recovery occurs before the decomposition at block 120, further steps will not discern a difference with respect to aligned features transferred from the frame captured under ambient lighting when compared to the frame captured using flash lighting, and further adjustments for these aligned features will be minimal. Further, the confidence value for the contribution of the strobe lighting to the at least one of the aligned features in FIG. 6 will be reduced.

According to some examples, the method includes generating, based on the decomposition data and at least one known characteristic of the strobe lighting, a thumbnail of a frame substantially illuminated with strobe-only lighting at block 122. For example, the central processing unit 1006 illustrated in FIG. 10 may generate a thumbnail of a frame substantially illuminated with strobe-only lighting by transforming the thumbnail version of the frame captured using flash lighting with recovered portions based on the decomposition data and at least one known characteristic of the strobe lighting. In addition to at least one known strobe characteristic the transforming can also take into account one or more lens characteristics. This could be important especially if one or versions of the frame captured using flash lighting or frame captured under ambient lighting were taken by different cameras.

More particularly, the present technology can access color values and light intensity values for pixels, among other characteristics, making up respective aligned features. In particular, the present technology is looking for the difference in values between the frame captured under ambient lighting and the frame captured using flash lighting. In areas where the pixels show the greatest difference between the frame captured under ambient lighting and the frame captured using flash lighting, the process has better data to work with since all of the differences should be from the effect of the strobe lighting. The strobe is well characterized; that is, the light temperature values for the strobe are known, the intensity of the strobe is known, and even the way the strobe distributes light is known. Using these known values, and adjusting for differences in exposure settings and (potentially) camera and lens sensitivities, the present technology can determine the colors of the aligned features as they would appear if the only illumination were the strobe lighting and generate the thumbnail of the frame substantially illuminated with strobe-only lighting. While it is not possible to capture a frame substantially illuminated with strobe-only lighting and substantially without ambient lighting, the present technology can take the frame captured using flash lighting and compare it with a frame captured under ambient lighting and then estimate values to generate the frame substantially illuminated with strobe-only lighting and substantially without ambient lighting in block 122.

While the method is addressed with respect to a single frame captured using flash lighting and a single frame captured under ambient lighting, it should be appreciated that the method can accommodate and benefit from additional versions of the frames.

According to some examples, the method includes white balancing the thumbnail version of the frame substantially illuminated with strobe-only lighting at block 130. For example, the image signal processor 1003 illustrated in FIG. 10 may white balance the thumbnail version of the frame substantially illuminated with strobe-only lighting. For example, the thumbnail version of the frame substantially illuminated with strobe-only lighting can be white balanced using an automatic white balancing algorithm based on a known strobe white point (color temperature).

According to some examples, the method includes correcting for the non-uniformity of the strobe lighting in the thumbnail using one or more pre-determined or estimated parameters based on the strobe angular profile at block 132. For example, the image signal processor 1003 illustrated in FIG. 10 may correct for the non-uniformity of the strobe lighting in the thumbnail using one or more pre-determined or estimated parameters based on the strobe profile. In some embodiments, the estimated parameters can include but are not limited to the strobe white point and illumination strength varying across the field of view in the frame captured using flash lighting. The point of the strobe angular profile correction is two-fold. First, the decreased strobe energy is predicted, and the signal-to-noise (SNR) of the strobe-only component is used to predict the SNR. It also helps to ensure that material with uniform brightness is rendered the same in the center of the frame substantially illuminated with strobe-only lighting and the edge of the frame substantially illuminated with strobe-only lighting even though the material at the edge of the frame will have a lower sensor response due to the decreased number of photons from the strobe at the edges of the image (in addition to any lens vignetting effects).

According to some examples, the method includes adjusting, utilizing an outlier-resilient style transfer algorithm, the at least one of the aligned features in the white balanced thumbnail version of the frame substantially illuminated with strobe-only lighting to yield at least one of the aligned features illuminated using the strobe lighting and substantially without the ambient lighting at block 134. For example, the image signal processor 1003 illustrated in FIG. 10 may adjust at least one of the aligned features to appear as if it were illuminated using the strobe lighting and substantially without the ambient lighting to yield a color-consistent frame. Since the characteristics of the strobe lighting are known, the image signal processor can consistently represent the aligned features based on the known white point value for the strobe.

An outlier-resilient style transfer algorithm is designed to apply the stylistic features of one image (the frame captured under ambient lighting) to the content of another image (the frame substantially illuminated with strobe-only lighting) while being resistant to anomalies or irregularities in the data. Style transfer algorithms typically analyze and replicate patterns, textures, and color schemes from the style reference onto the target image. The outlier-resilient aspect means that the algorithm is specially designed to handle and adapt to outliers in the dataset-elements that deviate significantly from the rest of the data. In the context of style transfer, outliers could be unusual color patterns, extreme contrasts, or unique textures in the style reference or target image that could potentially distort the transfer process. An outlier-resilient style transfer algorithm can manage these irregularities, ensuring that the style is applied consistently and effectively across the target image without being overly influenced by atypical data points. This makes the algorithm more robust and versatile, capable of delivering high-quality results even in challenging conditions.

In addition to transferring the style (color characteristics), the outlier-resilient style transfer algorithm can also up-sample the thumbnail version back into its full resolution to yield the color-consistent frame.

According to some examples, the method includes rendering the color-consistent frame at block 136. For example, the graphics processing unit 1012 illustrated in FIG. 10 may render the color-consistent frame. The at least one of the aligned features is rendered with more accurate and reproducible color tones and no shadows. Using the present technology, the same object or scene can be captured under different ambient lighting conditions, and the output color-consistent frame will have consistent colors.

As will be addressed in greater detail below, there is no shadow when you remove ambient lighting from the frame because the strobe is right next to the camera, and therefore the strobe does not produce any appreciable shadows.

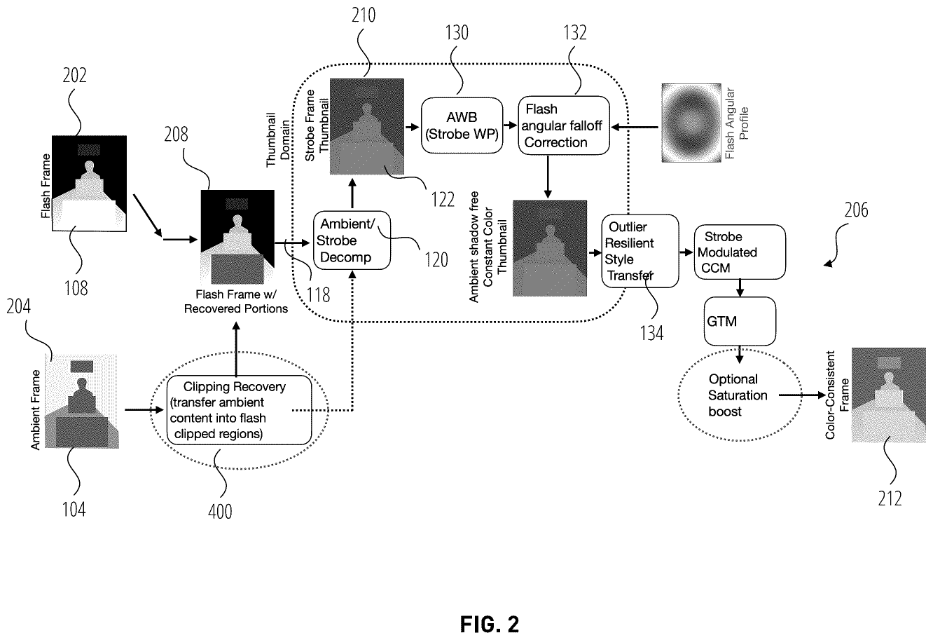

FIG. 2 illustrates an example schematic process showing some steps for the creation of a color-consistent frame in accordance with some embodiments of the present technology. Although the example system depicts particular system components and an arrangement of such components, this depiction is to facilitate a discussion of the present technology and should not be considered limiting unless specified in the appended claims. For example, some components that are illustrated as separate can be combined with other components, some components can be divided into separate components, some components might not be present or needed, and additional components may be present.

Some of the steps addressed above with respect to FIG. 1A and FIG. 1B, as well as a portion of FIG. 4 are labeled in FIG. 2. The omission or addition of one or more steps should have no effect on the interpretation of the present technology unless the appended claims require such an interpretation.

While the present technology has been addressed with respect to capturing the frame captured under ambient lighting 204 and the frame captured using flash lighting 202, these are not required steps. Another camera could capture both frames as long as the characteristics of the strobe are known. The present technology can be offered as an application programming interface (API) for providing color-consistent frames or shadowless frames, wherein the API need only receive the input frames and characteristics of the strobe used for the frame captured using flash lighting.

FIG. 2 shows a clipping recovery process that is addressed in greater detail in FIG. 4. This process can cause the frame captured using flash lighting with recovered portions 208 that are recovered from the frame captured under ambient lighting 204 to have regions where the color consistency is plausible, but confidence in the accuracy of such colors can be reduced or low. Thus, there can be use cases where clipping recovery is not desired, such as in a medical context or a fine color comparison context, where color-consistency is an overriding factor. There can also be use cases such as the creation of a legible scanned document where clipping recovery is more important to ensure the scan is legible at the expense of confidence in some colors of some aligned features. FIG. 2 illustrates additional-processing techniques 206 such as Strobe Modulated CCM (Color Correction Matrix), GTM (Global Tone Mapping), and optional saturation boost.

FIG. 3 illustrates an example matt haze mask creation process 300 for predicting whether at least one of the aligned features subject to matt haze or weak clipping in the frame captured using flash lighting in accordance with some embodiments of the present technology. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

Accordingly, when it is determined that at least one of the aligned features might be clipped at decision block 116, the method proceeds to matt haze mask creation process 300 in FIG. 3 to determine whether at least one of the aligned features is due to matt haze and to create a matt haze mask to be used in the recovery of details from the frame captured under ambient lighting.

The matt haze mask creation process 300 can begin with creation of or input of a thumbnail version of the frames captured under ambient lighting, a mask of the thumbnail of frame captured under ambient lighting, a frame captured using flash lighting clipping mask (which is a mask that has clipped aligned features removed), and a coarse version of the frame captured using flash lighting. A coarse version of the frame captured using flash lighting refers to an initial, rough representation or structure, characterized by a lower resolution or less detailed overview compared to subsequent, more refined representations. The coarse frame serves as the preliminary frame in multi-stage processing or analysis pipelines. This preliminary frame may capture essential spatial, temporal, or structural information, from which finer, more detailed frames are subsequently derived or against which they are refined.

According to some examples, the method includes calculating ambient and flash intensity images at block 302. For example, the central processing unit 1006 illustrated in FIG. 10 may calculate ambient and flash intensity images. Calculating an intensity image from a thumbnail version of the frame captured under ambient lighting and from a coarse version of the frame captured using flash lighting. In the intensity image pixels carry a value indicative of a certain amount of light intensity. The pixel values in an intensity image typically range from 0 to 255 for 8-bit images, where 0 represents black (no intensity), 255 denotes white (full intensity), and the values in between correspond to various shades of gray.

According to some examples, the method includes constructing a weight map at block 304. For example, the central processing unit 1006 illustrated in FIG. 10 may construct weight map from a thumbnail version of the frame captured under ambient lighting and a clipping mask of the frame captured using flash lighting. The weight map is used to exclude known clipped and near clipped regions from being learned in a gain transform (at block 306). The reason for this is that the clipped and near clipped regions are recovered on their own as a result of decision block 116 and detail transfer process 400 using the using the frame captured using flash lighting clipping mask. Therefore aligned features recovered in the clipping recovery steps can be excluded from the matt haze recovery in the matt haze mask creation process 300.

According to some examples, the method includes learning an intensity gain transform at block 306. For example, the central processing unit 1006 illustrated in FIG. 10 may learn an intensity gain transform by calculating a weighted intensity gain transform with intensity bands to transform the intensities of the frame captured under ambient lighting to the intensities of the coarse version of the frame captured using flash lighting using spatial and intensity weightings.

According to some examples, the method includes normalizing the ambient intensity image (from block 302) to the flash frame at block 308. For example, the central processing unit 1006 illustrated in FIG. 10 may normalize the intensity image from a thumbnail version of the frame captured under ambient lighting to the frame captured using flash lighting. The normalizing is performed to be able to measure small positive variations in a low frequency range of the frame, which characterizes changes in intensity over spatial regions within the image.

According to some examples, the method includes constructing a low-resolution intensity gain map at block 310. For example, the central processing unit 1006 illustrated in FIG. 10 may construct a low-resolution intensity gain map by applying the gain transform to the coarse version of the frame captured using flash lighting, wherein the low-resolution gain map excludes high-frequency detail.

According to some examples, the method includes constructing an ambient intensities normalized image at block 312. For example, the central processing unit 1006 illustrated in FIG. 10 may construct an ambient intensities normalized image.

According to some examples, the method includes classifying, the at least one of the aligned features as being subject to matt haze or not by a plurality of classifiers at block 314. For example, the central processing unit 1006 illustrated in FIG. 10 may classify, the at least one of the aligned features as being subject to matt haze or not by a plurality of classifiers. The plurality of classifiers include. A shadow detection classifier that detects shadow edges by finding regions with strong gradient changes in the intensity gain map. A quality of ambient content classifier that detects large gain changes in the intensity gain map between ambient and flash indicates more noise. A first white dot region classifier that finds regions with positive brightness changes from the ambient intensities normalized image and coarse version of the frame captured using flash lighting. A second white dot region classifier that finding regions with stronger image gradients in the ambient frame from the ambient intensities normalized image and coarse version of the frame captured using flash lighting. Of course, while the present technology utilizes multiple determinations, it is contemplated that these steps could be swapped for a machine learning process.

In some embodiments, depth values for details of at least one of the aligned features can also be used to estimate the surface normals and better predict which portions of at least one of the aligned features are likely to reflect strobe energy directly back to the camera and cause reflections. This can be used to determine whether at least one of the aligned features is experiencing clipping from the strobe lighting or matt haze from the texture of the surface. The depth can be determined from stereo images, a LiDAR sensor, a focus pixel, comparing multiple frames captured using strobe lighting and multiple frames captured under ambient lighting to observe motion, machine learning algorithms for estimating depth, etc.

At a high level the plurality of classifiers attempt to determine whether the aligned features have significantly lower contrast in the thumbnail version of the frame captured using flash lighting as compared to the thumbnail version of the frame captured under ambient lighting, or whether the strength of edges is significantly weaker in the thumbnail version of the frame captured using flash lighting as compared to the frame captured under ambient lighting, or whether a coherency of edge directions is lower in the thumbnail version of the frame captured using flash lighting as compared to the frame captured under ambient lighting.

In some embodiments, the outputs of the respective plurality of classifiers may need to be normalized somewhat through max pooling of the respective classifications and scaling the respective classifications to normalized values before the outputs of the respective plurality of classifiers can be combined into a fusion mask at block 316.

According to some examples, the method includes constructing a matt haze fusion mask from outputs from the plurality of classifiers at block 316. For example, the central processing unit 1006 illustrated in FIG. 10 may construct a matt haze fusion mask from outputs from the plurality of classifiers. The plurality of classifiers yields a fusion mask limits the transfer of poor-quality ambient regions (if the detail in the frame captured under ambient lighting is not good enough, the mask does not include it to be transferred by the detail transfer process), forces max correction on flash-clipped regions (the flash-clipped regions are recovered directly from a specific mask for flash-clipped aligned features), removes clipping correction on ambient clipped regions (the mask does not attempt to recover details from the ambient frame when the ambient frame also includes the same clipping, i.e., the clipping is not the result of the strobe), and limits transfer on shadow edges (the mask is configured to transfer detail from shadow regions without transferring the shadow). If the plurality of classifiers determines there is no matt haze, then the outcome is data valid and no detail transfer from the frame captured under ambient lighting is needed.

According to some examples, the method includes diffusing the fusion mask at block 318. For example, the central processing unit 1006 illustrated in FIG. 10 may diffuse fusion mask to ensure smooth transitions between the aligned features and the rest of the frame.

When it is determined that the aligned features are obscured due matt haze caused by the effects of the strobe, the method includes recovering a detail of at least one of the aligned features from the frame captured under ambient lighting for inclusion in the frame captured using flash lighting in detail transfer process 400 illustrated in FIG. 4.

FIG. 4 illustrates an example method for transferring clipped portions of a frame captured under ambient lighting into a frame captured using flash lighting in accordance with some embodiments of the present technology. Although the example method depicts a particular sequence of operations, the sequence may be altered without departing from the scope of the present disclosure. For example, some of the operations depicted may be performed in parallel or in a different sequence that does not materially affect the function of the method. In other examples, different components of an example device or system that implements the method may perform functions at substantially the same time or in a specific sequence.

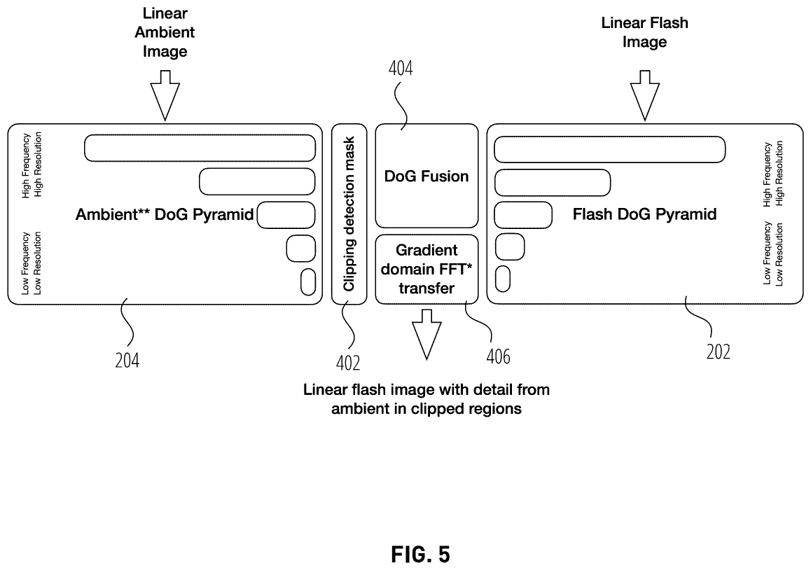

FIG. 5 illustrates an example schematic illustration of a clipping recovery process in accordance with some embodiments of the present technology. FIG. 4 will be discussed with reference to FIG. 5.

According to some examples, the method includes receive a fusion mask for clipped aligned features and for aligned features subject to matt haze at block 404. In some embodiments, these can be two different masks or the masks for the respective aligned features can be merged into a single mask.

According to some examples, the method includes performing a difference of Gaussian pyramid fusion technique to transfer high-frequency aspects of at least one aligned feature identified as clipped or subject to matt haze in the fusion mask from the frame captured under ambient lighting into the frame captured using flash lighting at block 404. Aligned features of the frame captured using flash lighting that are not affected by clipping or matt haze are not transferred using this process. For example, the central processing unit 1006 illustrated in FIG. 10 may perform a difference of Gaussian pyramid fusion technique to transfer high-frequency aspects of at least one aligned feature, as guided by the fusion mask, from the frame captured under ambient lighting into the frame captured using flash lighting. This method is particularly effective in transferring the high-frequency aspects of the aligned features—these include fine details, edges, and textures that contribute to the sharpness and clarity of the image. The difference of Gaussian technique works by creating a multi-level pyramid structure where each level represents the image filtered at a different scale, emphasizing the details that vary between these scales. By fusing these levels together, the method selectively transfers the intricate details from the frame captured under ambient lighting into the color-consistent frame, thereby enhancing the perceived texture and clarity while maintaining the overall color balance achieved through earlier processing steps.

According to some examples, the method includes performing a gradient-domain transfer using a Fast Fourier Transform (FFT) for low-frequency aspects of at least one aligned feature from the frame captured under ambient lighting into the frame captured using flash lighting at block 406. For example, the central processing unit 1006 illustrated in FIG. 10 may perform a gradient-domain transfer using a Fast Fourier Transform (FFT) for low-frequency aspects, guided by the fusion mask, of at least one aligned feature from the frame captured under ambient lighting into the color-consistent frame. The gradient-domain transfer using a Fast Fourier Transform (FFT) integrates the low-frequency components of the aligned features to address broader color and intensity gradients that define the overall tone and ambiance of the image. This is accomplished through a gradient-domain transfer, employing a Fast Fourier Transform (FFT) to efficiently manipulate the image in the frequency domain. The Fast Fourier Transform (FFT) enables the transfer of texture without transferring the tone/shadows. This is what enables fine detail to be transferred while minimizing the transferring of unwanted ambient shadows.

After the detail of at least one of the aligned features has been recovered from the frame captured under ambient lighting at in the detail transfer process 400, the method returns to block 120. Since the clipping recovery occurs before the decomposition at block 120, further steps will not discern a difference with respect to aligned features transferred from the frame captured under ambient lighting when compared to the frame captured using flash lighting, and further adjustments for these aligned features will be minimal. Further, the confidence value for the contribution of the strobe lighting to at least one of the aligned features at block 126 will be reduced

As was addressed above, the color-consistent frame is created from the frame captured using flash lighting while using the frame captured under ambient lighting as a reference for some details. The frame captured using flash lighting has the benefit that no shadows are present once the ambient lighting is removed. However, if the frame captured using flash lighting were modified to copy a shadow from the frame captured under ambient lighting, this could introduce shadows into the color-consistent frame.

Persons of ordinary skill in the art may appreciate that the color-consistent frame might not be fully color-consistent since some portions of the frame captured under ambient lighting are copied in the frame captured using flash lighting. Therefore, the color-consistent frame can include some aligned features that are not as color-consistent as the rest of the aligned features that were not obscured due to clipping. While a small portion of the color-consistent frame might not be as color-consistent as the rest of the frame, the color-consistent frame still represents a big improvement over the state of the art.

FIG. 6 illustrates an example method for outputting a visual confidence map in accordance with some embodiments of the present technology. Although the example method depicts a particular sequence of operations, the sequence may be altered without departing from the scope of the present disclosure. For example, some of the operations depicted may be performed in parallel or in a different sequence that does not materially affect the function of the method. In other examples, different components of an example device or system that implements the method may perform functions at substantially the same time or in a specific sequence.

According to some examples, the method includes outputting a visual confidence map that indicates portions of the color-consistent frame that have accurate colors and portions of the color-consistent frame that have plausible but possibly not accurate colors at block 602. For example, the central processing unit 1006 illustrated in FIG. 10 may output a visual confidence map that indicates portions of the color-consistent frame that have accurate colors and portions of the color-consistent frame that have plausible but possibly not accurate colors. The visual confidence map is output so a consumer of the image can tell how confident the image signal processor is about the color tones. The visual confidence map is created from factors including: the signal-to-noise ratio of at least one aligned feature of the frame captured using flash lighting and frame captured under ambient lighting, signal-to-noise ratio of the delta between at least one aligned feature in the frame captured using flash lighting and frame captured under ambient lighting, presence of clipping in the at least one aligned features in the frame captured using flash lighting and/or frame captured under ambient lighting, accuracy of registration for the at least one frame captured using flash lighting and frame captured under ambient lighting; distance to the surfaces in the frame from the strobe, and an accuracy to which the strobe white point is known.

In some embodiments, multiple frames captured using strobe lighting and multiple frames captured under ambient lighting can be used to improve the quality, signal-to-noise ratio, accuracy, or registration of the color-consistent frame.

The visual confidence map can be useful for a consumer of the color-consistent frame who wants to rely on the colors in the color-consistent frame. For example, a doctor engaging in a digital health service would want to know if a feature relevant to a diagnosis has accurate color or if the color value is less certain.

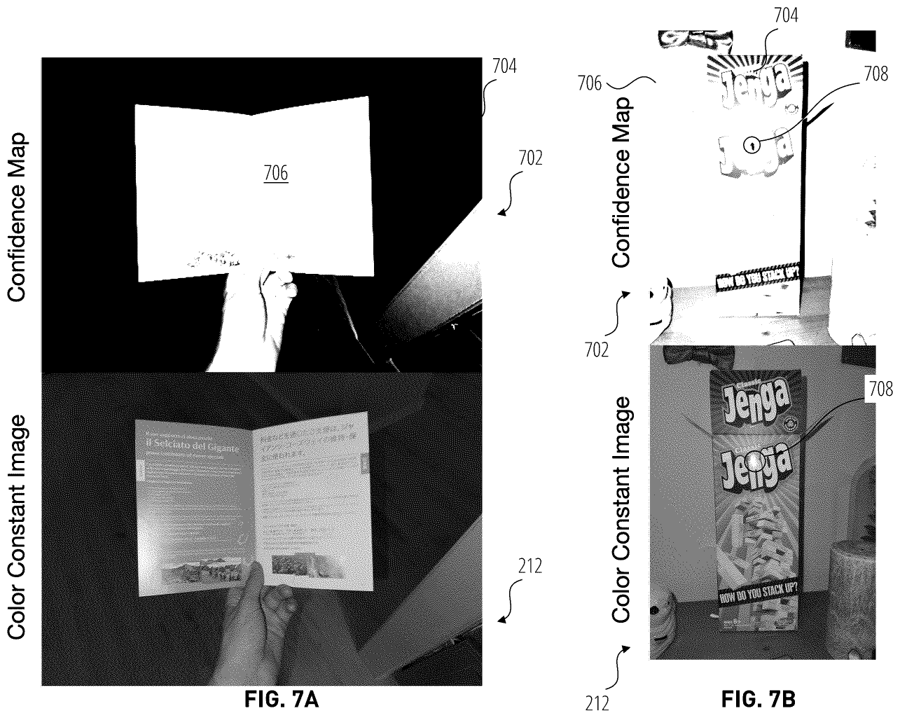

FIG. 7A and FIG. 7B illustrates examples of a visual confidence map in accordance with some embodiments of the present technology.

The bottom portions of FIG. 7A and FIG. 7B are the respective color-consistent frame 212, and the top portions are the visual confidence map 702. The white portions are high confidence features 706, where the process has high confidence in the reproducibility of the color, whereas the darker portions, especially the black portions, are low confidence features 704. Low confidence features 704 can be the result of black or darker colors since they reflect less light. The addition of the strobe lighting provides too little of a difference between the frame captured under ambient lighting and the frame captured using flash lighting for dark features, and therefore, the process provides a low confidence value.

Clipping can also lead to low confidence, as illustrated by clipped feature 708. In the color-consistent frame 212, the clipped feature 708 is a bright white spot, and this translates to a low-confidence dark area in visual confidence map 702 of FIG. 7B. Clipped feature 708 is an example where the optional clipping recovery was not enabled, which is why it is observable in color-consistent frame 212. However, if the detail were recovered such that clipped feature 708 was not apparent in color-consistent frame 212, it would still be indicated as low confidence in visual confidence map 702 so that the consumer of the data knows that portion of color-consistent frame 212 might not have accurate colors.

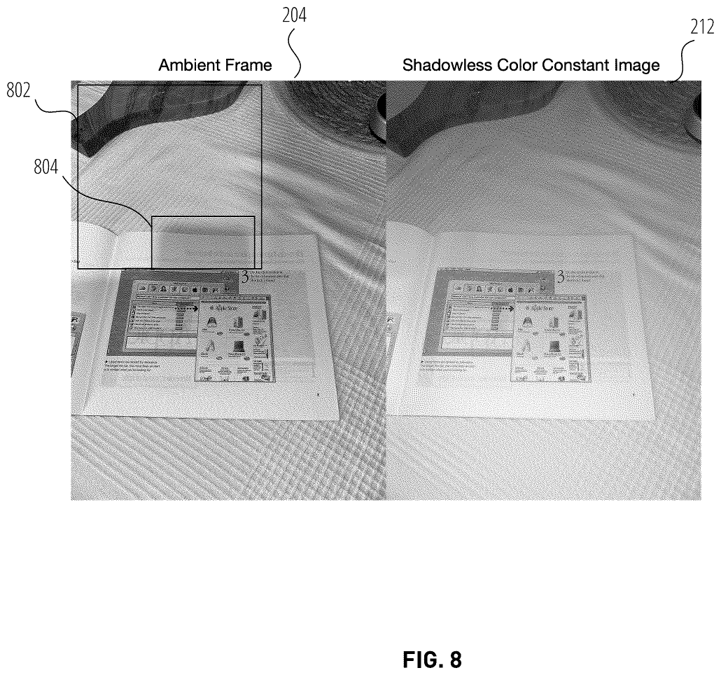

FIG. 8 illustrates an example of a frame captured under ambient lighting and a color-consistent frame without shadows in accordance with some embodiments of the present technology. For example, FIG. 8 illustrates frame captured under ambient lighting 204 with an ambient light region 802, and within the ambient light region 802 is a shadow caused by ambient light 804. In color-consistent frame 212, the ambient light region 802 and shadow caused by ambient light 804 have been removed since the lighting in the color-consistent frame 212 is predominantly from the strobe.

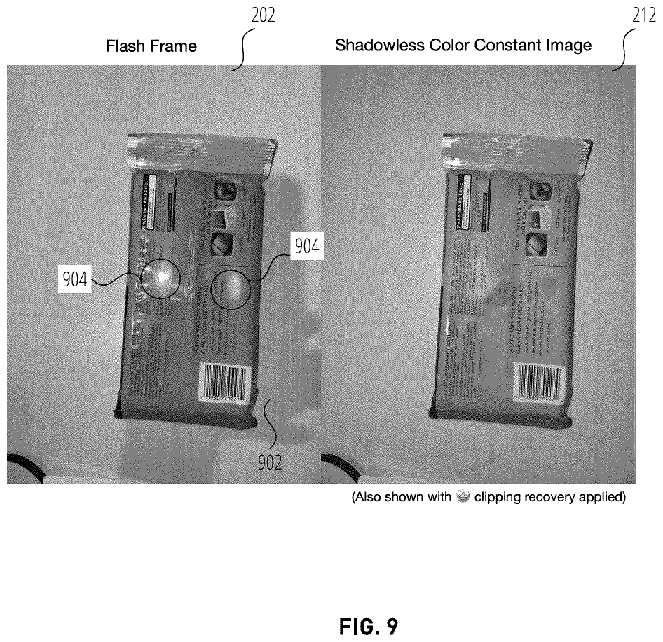

FIG. 9 illustrates an example of a frame captured under ambient lighting and color-consistent frame with clipping recovery in accordance with some embodiments of the present technology. For example, FIG. 9 illustrates the frame captured using flash lighting 202 with a shadow 902 and with clipped regions 904. In color-consistent frame 212, shadow 902 has been removed since the lighting in color-consistent frame 212 is predominantly from the strobe. The clipped region 904 has also been recovered from the frame captured under ambient lighting.

FIG. 10 is a system diagram illustrating device 1000 in accordance with some embodiments of the present technology. Although the example system depicts particular system components and an arrangement of such components, this depiction is to facilitate a discussion of the present technology and should not be considered limiting unless specified in the appended claims. For example, some components that are illustrated as separate can be combined with other components, some components can be divided into separate components, some components might not be present or needed, and additional components may be present.

Device 1000 may perform various operations including image processing. For this and other purposes, the device 1000 may include, among other components, image sensor 1001, system-on-a system on a chip 1002, system memory 1017, persistent storage 1016, motion sensor 1019, and display 1010.

Image sensor 1001 is a component for capturing image data and may be embodied, for example, as a complementary metal-oxide-semiconductor (CMOS) active-pixel sensor) a camera, video camera, or other devices. Image sensor 1001 generates raw image data that is sent to system on a chip 1002 for further processing. In some embodiments, the image data processed by system on a chip 1002 is displayed on display 1010, stored in system memory 1017, persistent storage 1016 or sent to a remote computing device via network connection. The raw image data generated by image sensor 1001 may be in a Bayer color filter array (CFA) pattern (hereinafter also referred to as “Bayer pattern”).

Strobe controller 1005 is a component for controlling variable features of strobe 1004. Some attributes of the strobe 1004 profile that can be adjusted include a strobe duration, a strobe strength, strobe spectrum, and an angular profile. For example, some strobe 1004 devices can include strobes with adjustable intensities, and some strobe devices include multiple strobes, maybe with different emission spectra that can be activated independently to control an angular profile or spectrum of the light emitted from the strobe. An angular profile refers to the pattern and spread of light emitted from the strobe unit as it disperses over an area, as well as how this dispersion changes at different angles relative to the strobe. This can include how the intensity and distribution of light vary as one moves away from the central axis of the strobe, which is directly in front of it, towards the sides.

Motion sensor 1019 is a component or a set of components for sensing motion of device 1000. Motion sensor 1019 may generate sensor signals indicative of orientation and/or acceleration of device 1000. The sensor signals are sent to system on a chip 1002 for various operations such rotating images displayed on display 1010, and tracking motion of the image sensor 1001 during image capture.

Display 1010 is a component for displaying images as generated by system on a chip 1002. Display 1010 may include, for example, liquid crystal display (LCD) device or an organic light emitting diode (OLED) device. Based on data received from system on a chip 1002, display 1010 may display various images, such as menus, selected operating parameters, images captured by image sensor 1001 and processed by system on a chip 1002, and/or other information received from a user interface of device 1000 (not shown).

System memory 1017 is a component for storing instructions for execution by system on a chip 1002 and for storing data processed by system on a chip 1002. System memory 1017 may be embodied as any type of memory including, for example, dynamic random access memory (DRAM), synchronous DRAM (SDRAM), double data rate (DDR, DDR2, DDR3, etc.) RAMBUS DRAM (RDRAM), static RAM (SRAM) or a combination thereof. In some embodiments, system memory 1017 may store pixel data or other image data or statistics in various formats. System memory 1017 can be accessible by many of the components of the system on a chip 1002, including, but not limited to the central processing unit 1006, graphics processing unit 1012, and neural engine 1020.

Persistent storage 1016 is a component for storing data in a non-volatile manner.

Persistent storage 1016 retains data even when power is not available. Persistent storage 1016 may be embodied as read-only memory (ROM), NAND or NOR strobe memory or other non-volatile random access memory devices.

System on a chip 1002 is embodied as one or more integrated circuit (IC) chips and performs various data processing processes. System on a chip 1002 may include, among other components, image signal processor 1003, one or more central processing unit 1006, network interface 1007, sensor interface 1008, display controller 1009, one or more graphics processing unit 1012, memory controller 1013, video encoder 1014, storage controller 1015, one or more neural engine 1020 and various other input/output (I/O) I/O interfaces 1011, and bus 1018. Some components of system on a chip 1002 can be connected directly to system memory 1017, while other components are connect to other components by bus 1018. System on a chip 1002 may include more or fewer components than those shown in FIG. 10.

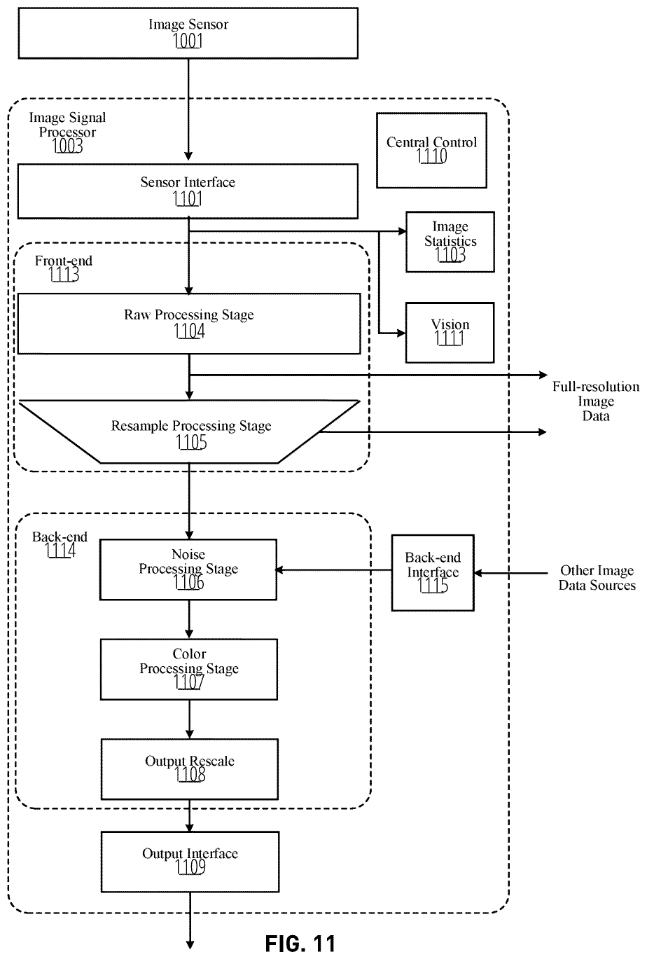

Image signal processor 1003 (ISP) is hardware that performs various stages of an image processing pipeline. In some embodiments, image signal processor 1003 may receive raw image data from image sensor 1001, and process the raw image data into a form that is usable by other subcomponents of system on a chip 1002 or components of device 1000. image signal processor 1003 may perform various image-manipulation operations such as image translation operations, horizontal and vertical scaling, color space conversion and/or image stabilization transformations, as described below in detail with reference to FIG. 11.

Central processing unit 1006 (CPU) may be embodied using any suitable instruction set architecture, and may be configured to execute instructions defined in that instruction set architecture. Central processing unit 1006 may be general-purpose or embedded processors using any of a variety of instruction set architectures (ISAs), such as the x86, PowerPC, SPARC, RISC, ARM or MIPS ISAs, or any other suitable ISA. Although a single CPU is illustrated in FIG. 10, system on a chip 1002 may include multiple CPUs. In multiprocessor systems, each of the CPUs may commonly, but not necessarily, implement the same ISA.

Graphics processing unit 1012 (GPU) is graphics processing circuitry for performing graphical data. For example, GPU may render objects to be displayed into a frame buffer (e.g., one that includes pixel data for an entire frame). Graphics processing unit 1012 may include one or more graphics processors that may execute graphics software to perform a part or all of the graphics operation, or hardware acceleration of certain graphics operations.

Neural engine 1020 includes one or more processing cores optimized for machine learning tasks including training and inference tasks. Neural engine 1020 enables rapid processing of artificial intelligence (AI) and machine learning (ML) operations. Neural engine 1020 is optimized for tasks such as advanced image processing, natural language processing, and pattern recognition, significantly improving the efficiency and speed of AI-related processes. Its architecture is designed to support a wide range of machine learning models while being highly energy-efficient, thereby enhancing the user experience through faster, more responsive applications and functionalities that rely on AI and ML technologies.

I/O interfaces 1011 are hardware, software, firmware or combinations thereof for interfacing with various input/output components in device 1000. I/O components may include devices such as keypads, buttons, audio devices, and sensors such as a global positioning system. I/O interfaces 1011 process data for sending data to such I/O components or process data received from such I/O components.

Network interface 1007 is enables data to be exchanged between devices device 1000 and other devices via one or more networks (e.g., carrier or agent devices). For example, video or other image data may be received from other devices via network interface 1007 and be stored in system memory 1017 for subsequent processing (e.g., via a back-end interface to image signal processor 1003, such as discussed below in FIG. 11) and display. The networks may include, but are not limited to, Local Area Networks (LANs) (e.g., an Ethernet or corporate network) and Wide Area Networks (WANs). The image data received via network interface 1007 may undergo image processing processes by image signal processor 1003.

Sensor interface 1008 is circuitry for interfacing with motion sensor 1019. Sensor interface 1008 receives sensor information from motion sensor 1019 and processes the sensor information to determine the orientation or movement of the device 1000.

Display controller 1009 is circuitry for sending image data to be displayed on display 1010. Display controller 1009 receives the image data from image signal processor 1003, central processing unit 1006, graphics processing unit 1012 or system memory 1017 and processes the image data into a format suitable for display on display 1010.

Memory controller 1013 is circuitry for communicating with system memory 1017. Memory controller 1013 may read data from system memory 1017 for processing by image signal processor 1003, central processing unit 1006, graphics processing unit 1012 or other subcomponents of system on a chip 1002. Memory controller 1013 may also write data to system memory 1017 received from various subcomponents of system on a chip 1002.

Video encoder 1014 is hardware, software, firmware or a combination thereof for encoding video data into a format suitable for storing in persistent storage 1016 or for passing the data to network interface 1007 for transmission over a network to another device.

In some embodiments, one or more components of system on a chip 1002 or some functionality of these components may be performed by software components executed on image signal processor 1003, central processing unit 1006, graphics processing unit 1012. Such software components may be stored in system memory 1017, persistent storage 1016 or another device communicating with device 1000 via network interface 1007.

Image data or video data may flow through various data paths within system on a chip 1002. In one example, raw image data may be generated from the image sensor 1001 and processed by image signal processor 1003, and then sent to system memory 1017. After the image data is stored in system memory 1017, it may be accessed by graphics processing unit 1012, neural engine 1020, and/or video encoder 1014 for encoding or display 1010.

In another example, image data is received from sources other than the image sensor 1001. For example, video data may be streamed, downloaded, or otherwise communicated to the system on a chip 1002 via wired or wireless network. The image data may be received via network interface 1007 and written to system memory 1017 via memory controller 1013. The image data may then be obtained from system memory 1017 and processed image signal processor 1003, graphics processing unit 1012, or neural engine 1020. The image data may then be returned to system memory 1017.

FIG. 11 is a system diagram illustrating image processing pipelines implemented using image signal processor 1003 in accordance with some embodiments of the present technology. Although the example system depicts particular system components and an arrangement of such components, this depiction is to facilitate a discussion of the present technology and should not be considered limiting unless specified in the appended claims. For example, some components that are illustrated as separate can be combined with other components, some components can be divided into separate components, some components might not be present or needed, and additional components may be present.

In the FIG. 11, image signal processor 1003 is coupled to image sensor 1001 to receive raw image data. Image signal processor 1003 implements an image processing pipeline which may include a set of stages that process image information from creation, capture, or receipt to output. Image signal processor 1003 may include, among other components, sensor interface 1101, central control 1110, front-end pipeline stages 1113, back-end pipeline stages 1114, image statistics service 1103, vision module 1111, back-end interface 1115, and output interface 1109. image signal processor 1003 may include other components not illustrated in FIG. 11 or may omit one or more components illustrated in FIG. 11.

In one or more embodiments, different components of image signal processor 1003 process image data at different rates. For example, in FIG. 11, front-end pipeline stages 1113 (e.g., raw processing stage 1104 and resample processing stage 1105) may process image data at an initial rate. Thus, the various different techniques, adjustments, modifications, or other processing operations are performed by these front-end pipeline stages 1113 at the initial rate. For example, if the front-end pipeline stages 1113 process 2 pixels per clock cycle, then resample processing stage 1105 operations (e.g., black level compensation, highlight recovery, and defective pixel correction) may process 2 pixels of image data at a time. In contrast, one or more back-end pipeline stages 1114 may process image data at a different rate less than the initial data rate. For example, in FIG. 11, back-end pipeline stages 1114 (e.g., noise processing stage 1106, color processing stage 1107, and output rescale service 1108) may be processed at a reduced rate (e.g., 1 pixel per clock cycle). Although embodiments described herein include embodiments in which the one or more back-end pipeline stages 1114 process image data at a different rate than an initial data rate, in some embodiments back-end pipeline stages 1114 may process image data at the initial data rate.

Sensor interface 1101 receives raw image data from image sensor 1001 and processes the raw image data into an image data processable by other stages in the pipeline. Sensor interface 1101 may perform various preprocessing operations, such as image cropping, binning or scaling to reduce image data size. In some embodiments, pixels are sent from the image sensor 1001 to sensor interface 1101 in raster order (i.e., horizontally, line by line). The subsequent processes in the pipeline may also be performed in raster order and the result may also be output in raster order. Although only a single image sensor 1001 and a single sensor interface 1101 are illustrated in FIG. 11, when more than one image sensor is provided in system on a chip 1002, a corresponding number of sensor interfaces may be provided in image signal processor 1003 to process raw image data from each image sensor.

Front-end pipeline stages 1113 process image data in raw or full-color domains. Front-end pipeline stages 1113 may include, but are not limited to, raw processing stage 1104 and resample processing stage 1105. A raw image data may be in Bayer raw format, for example. In Bayer raw image format, pixel data with values specific to a particular color (instead of all colors) is provided in each pixel. In an image sensor 1001, image data is typically provided in a Bayer pattern. Resample processing stage 1105 may process image data in a Bayer raw format.

The operations performed by resample processing stage 1105 include, but are not limited, sensor linearization, black level compensation, fixed pattern noise reduction, defective pixel correction, raw noise filtering, lens shading correction, white balance gain, and highlight recovery. Sensor linearization refers to mapping non-linear image data to linear space for other processing. Black level compensation refers to providing digital gain, offset and clip independently for each color component (e.g., Gr, R, B, Gb) of the image data. Fixed pattern noise reduction refers to removing offset fixed pattern noise and gain fixed pattern noise by subtracting a dark frame from an input image and multiplying different gains to pixels. Defective pixel correction refers to detecting defective pixels, and then replacing defective pixel values. Raw noise filtering refers to reducing noise of image data by averaging neighbor pixels that are similar in brightness. Highlight recovery refers to estimating pixel values for those pixels that are clipped (or nearly clipped) from other channels. Lens shading correction refers to applying a gain per pixel to compensate for a dropoff in intensity roughly proportional to a distance from a lens optical center. White balance gain refers to providing digital gains for white balance, offset and clip independently for all color components (e.g., Gr, R, B, Gb in Bayer format). Components of image signal processor 1003 may convert raw image data into image data in full-color domain, and thus, resample processing stage 1105 may process image data in the full-color domain in addition to or instead of raw image data.

Resample processing stage 1105 performs various operations to convert, resample, or scale image data received from raw processing stage 1104. Operations performed by resample processing stage 1105 may include, but not limited to, demosaic operation, per-pixel color correction operation, Gamma mapping operation, color space conversion and downscaling or sub-band splitting. Demosaic operation refers to converting or interpolating missing color samples from raw image data (for example, in a Bayer pattern) to output image data into a full-color domain. Demosaic operation may include low pass directional filtering on the interpolated samples to obtain full-color pixels. Per-pixel color correction operation refers to a process of performing color correction on a per-pixel basis using information about relative noise standard deviations of each color channel to correct color without amplifying noise in the image data. Gamma mapping refers to converting image data from input image data values to output data values to perform special image effects, including black and white conversion, sepia tone conversion, negative conversion, or solarize conversion. For the purpose of Gamma mapping, lookup tables (or other structures that index pixel values to another value) for different color components or channels of each pixel (e.g., a separate lookup table for Y, Cb, and Cr color components) may be used. Color space conversion refers to converting color space of an input image data into a different format. In one embodiment, resample processing stage 1105 converts RBD format into YCbCr format for further processing.

Central control 1110 may control and coordinate overall operation of other components in image signal processor 1003. Central control 1110 performs operations including, but not limited to, monitoring various operating parameters (e.g., logging clock cycles, memory latency, quality of service, and state information), updating or managing control parameters for other components of image signal processor 1003, and interfacing with sensor interface 1101 to control the starting and stopping of other components of image signal processor 1003. For example, central control 1110 may update programmable parameters for other components in image signal processor 1003 while the other components are in an idle state. After updating the programmable parameters, central control 1110 may place these components of image signal processor 1003 into a run state to perform one or more operations or tasks. Central control 1110 may also instruct other components of image signal processor 1003 to store image data (e.g., by writing to system memory 1017 in FIG. 10) before, during, or after resample processing stage 1105. In this way full-resolution image data in raw or full-color domain format may be stored in addition to or instead of processing the image data output from resample processing stage 1105 through back-end pipeline stages 1114.

Image statistics service 1103 performs various operations to collect statistic information associated with the image data. The operations for collecting statistics information may include, but not limited to, sensor linearization, mask patterned defective pixels, sub-sample raw image data, detect and replace non-patterned defective pixels, black level compensation, lens shading correction, and inverse black level compensation. After performing one or more of such operations, statistics information such as 3A statistics (Auto white balance (AWB), auto exposure (AE), auto focus (AF)), histograms (e.g., 2D color or component) and any other image data information may be collected or tracked. In some embodiments, certain pixels' values, or areas of pixel values may be excluded from collections of certain statistics data (e.g., AF statistics) when preceding operations identify clipped pixels. Although only an image statistics service 1103 is illustrated in FIG. 11, multiple image statistics modules may be included in image signal processor 1003. In such embodiments, each statistic module may be programmed by central control 1110 to collect different information for the same or different image data.

Vision module 1111 performs various operations to facilitate computer vision operations at central processing unit 1006 or neural engine 1020 such as facial detection in image data. The vision module 1111 may perform various operations including pre-processing, global tone-mapping and Gamma correction, vision noise filtering, resizing, keypoint detection, convolution and generation of histogram-of-orientation gradients (HOG). The pre-processing may include subsampling or binning operation and computation of luminance if the input image data is not in YCrCb format. Global mapping and Gamma correction can be performed on the pre-processed data on luminance image. Vision noise filtering is performed to remove pixel defects and reduce noise present in the image data, and thereby, improve the quality and performance of subsequent computer vision algorithms. Such vision noise filtering may include detecting and fixing dots or defective pixels, and performing bilateral filtering to reduce noise by averaging neighbor pixels of similar brightness. Various vision algorithms use images of different sizes and scales. Resizing of an image is performed, for example, by binning or linear interpolation operation. Keypoints are locations within an image that are surrounded by image patches well suited to matching in other images of the same scene or object. Such keypoints are useful in image alignment, computing cameral pose and object tracking. Keypoint detection refers to the process of identifying such keypoints in an image. Convolution may be used in image/video processing and machine vision. Convolution may be performed, for example, to generate edge maps of images or smoothen images. HOG provides descriptions of image patches for tasks in mage analysis and computer vision. HOG can be generated, for example, by (i) computing horizontal and vertical gradients using a simple difference filter, (ii) computing gradient orientations and magnitudes from the horizontal and vertical gradients, and (iii) binning the gradient orientations.

Back-end interface 1115 receives image data from other image sources than image sensor 1001 and forwards it to other components of image signal processor 1003 for processing. For example, image data may be received over a network connection and be stored in system memory 1017. Back-end interface 1115 retrieves the image data stored in system memory 1017 and provide it to back-end pipeline stages 1114 for processing. One of many operations that are performed by back-end interface 1115 is converting the retrieved image data to a format that can be utilized by back-end pipeline stages 1114. For instance, back-end interface 1115 may convert RGB, YCbCr 4:2:0, or YCbCr 4:2:2 formatted image data into YCbCr 4:4:4 color format.

Back-end pipeline stages 1114 processes image data according to a particular full-color format (e.g., YCbCr 4:4:4 or RGB). In some embodiments, components of the back-end pipeline stages 1114 may convert image data to a particular full-color format before further processing. Back-end pipeline stages 1114 may include, among other stages, noise processing stage 1106 and color processing stage 1107. Back-end pipeline stages 1114 may include other stages not illustrated in FIG. 11.

Noise processing stage 1106 performs various operations to reduce noise in the image data. The operations performed by noise processing stage 1106 include, but are not limited to, color space conversion, gamma/de-gamma mapping, temporal filtering, noise filtering, luma sharpening, and chroma noise reduction. The color space conversion may convert an image data from one color space format to another color space format (e.g., RGB format converted to YCbCr format). Gamma/de-gamma operation converts image data from input image data values to output data values to perform special image effects. Temporal filtering filters noise using a previously filtered image frame to reduce noise. For example, pixel values of a prior image frame are combined with pixel values of a current image frame. Noise filtering may include, for example, spatial noise filtering. Luma sharpening may sharpen luma values of pixel data while chroma suppression may attenuate chroma to gray (i.e. no color). In some embodiment, the luma sharpening and chroma suppression may be performed simultaneously with spatial nose filtering. The aggressiveness of noise filtering may be determined differently for different regions of an image. Spatial noise filtering may be included as part of a temporal loop implementing temporal filtering. For example, a previous image frame may be processed by a temporal filter and a spatial noise filter before being stored as a reference frame for a next image frame to be processed. In other embodiments, spatial noise filtering may not be included as part of the temporal loop for temporal filtering (e.g., the spatial noise filter may be applied to an image frame after it is stored as a reference image frame (and thus is not a spatially filtered reference frame).

Color processing stage 1107 may perform various operations associated with adjusting color information in the image data. The operations performed in color processing stage 1107 include, but are not limited to, local tone mapping, gain/offset/clip, color correction, three-dimensional color lookup, gamma conversion, and color space conversion. Local tone mapping refers to spatially varying local tone curves in order to provide more control when rendering an image. For instance, a two-dimensional grid of tone curves (which may be programmed by the central control 1110) may be bi-linearly interpolated such that smoothly varying tone curves are created across an image. In some embodiments, local tone mapping may also apply spatially varying and intensity varying color correction matrices, which may, for example, be used to make skies bluer while turning down blue in the shadows in an image. Digital gain/offset/clip may be provided for each color channel or component of image data. Color correction may apply a color correction transform matrix to image data. 3D color lookup may utilize a three dimensional array of color component output values (e.g., R, G, B) to perform advanced tone mapping, color space conversions, and other color transforms. Gamma conversion may be performed, for example, by mapping input image data values to output data values in order to perform gamma correction, tone mapping, or histogram matching. Color space conversion may be implemented to convert image data from one color space to another (e.g., RGB to YCbCr). Other processing techniques may also be performed as part of color processing stage 1107 to perform other special image effects, including black and white conversion, sepia tone conversion, negative conversion, or solarize conversion.

Output rescale service 1108 may resample, transform and correct distortion on the fly as the image signal processor 1003 processes image data. Output rescale service 1108 may compute a fractional input coordinate for each pixel and uses this fractional coordinate to interpolate an output pixel via a polyphase resampling filter. A fractional input coordinate may be produced from a variety of possible transforms of an output coordinate, such as resizing or cropping an image (e.g., via a simple horizontal and vertical scaling transform), rotating and shearing an image (e.g., via non-separable matrix transforms), perspective warping (e.g., via an additional depth transform) and per-pixel perspective divides applied in piecewise in strips to account for changes in image sensor during image data capture (e.g., due to a rolling shutter), and geometric distortion correction (e.g., via computing a radial distance from the optical center in order to index an interpolated radial gain table, and applying a radial perturbance to a coordinate to account for a radial lens distortion).

Output rescale service 1108 may apply transforms to image data as it is processed at output rescale service 1108. Output rescale service 1108 may include horizontal and vertical scaling components. The vertical portion of the design may implement a series of image data line buffers to hold the “support” needed by the vertical filter. As image signal processor 1003 may be a streaming device, it may be that only the lines of image data in a finite-length sliding window of lines are available for the filter to use. Once a line has been discarded to make room for a new incoming line, the line may be unavailable. Output rescale service 1108 may statistically monitor computed input Y coordinates over previous lines and use it to compute an optimal set of lines to hold in the vertical support window. For each subsequent line, output rescale service 1108 may automatically generate a guess as to the center of the vertical support window. In some embodiments, output rescale service 1108 may implement a table of piecewise perspective transforms encoded as digital difference analyzer (DDA) steppers to perform a per-pixel perspective transformation between input image data and output image data in order to correct artifacts and motion caused by sensor motion during the capture of the image frame. Output rescale may provide image data via output rescale service 1108 to various other components of device 1000, as discussed above with regard to FIG. 10.

In some embodiments, the functionally of components 1102 through 1115 may be performed in a different order than the order implied by the order of these functional units in the image processing pipeline illustrated in FIG. 11, or may be performed by different functional components than those illustrated in FIG. 11. Moreover, the various components as described in FIG. 11 may be embodied in various combinations of hardware, firmware or software.

For clarity of explanation, in some instances, the present technology may be presented as including individual functional blocks including functional blocks comprising devices, device components, steps or methods in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a device and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, strobe memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

### ASPECTS

The present technology includes computer-readable storage mediums for storing instructions, and systems for executing any one of the methods embodied in the instructions addressed in the aspects of the present technology presented below:
Aspect 1: A method includes receiving, by an image signal processor, a frame captured under ambient lighting and a frame captured using flash lighting, performing, by the image signal processor, a global registration comparing the frame captured under ambient lighting with the frame captured using flash lighting to yield aligned features present in the frame captured under ambient lighting and the frame captured using flash lighting, calculating, by the image signal processor, based on a comparison of the frame captured under ambient lighting with the frame captured using flash lighting and at least one known characteristic of strobe lighting in the frame captured using flash lighting, a contribution of the ambient lighting to the at least one of the aligned features in the frame captured using flash lighting and a contribution of the strobe lighting to the at least one of the aligned features in the frame captured using flash lighting, adjusting, by the image signal processor, the at least one of the aligned features in the frame captured using flash lighting to yield a frame substantially illuminated with strobe-only lighting based on the calculated contribution of the ambient lighting and the contribution of the strobe lighting, and rendering, by the image signal processor, the at least one of the aligned features illuminated using the strobe lighting and substantially without the ambient lighting in a color-consistent frame.
Aspect 2: The method of Aspect 1, may also include generating the color-consistent frame using an outlier-resilient style transfer algorithm to process the frame substantially illuminated with strobe-only lighting to create a high-fidelity full-resolution color constancy output that is the color-consistent frame. Other technical features may be readily apparent to one skilled in the art from the following figures, descriptions, and claims.
Aspect 3: The method of any one of Aspects 1-2 may also include prior to capturing the frame captured under ambient lighting, determining, by an auto exposure algorithm, one or more ambient frame exposure parameters to result in the frame captured under ambient lighting that is optimized for accurate decomposition, prior to capturing the frame captured using flash lighting, determining, by the auto exposure algorithm, one or more strobe frame exposure parameters and/or a strobe profile that is predicted to result in the frame captured using flash lighting that is optimized for accurate decomposition, wherein adjustable attributes of the strobe profile include a strobe duration, strobe brightness and a strobe strength as a function of angle. Other technical features may be readily apparent to one skilled in the art from the following figures, descriptions, and claims.
Aspect 4: The method of any one of Aspects 1-3 may also include where the one or more strobe frame exposure parameters and/or a strobe profile are determined based on an estimate the reflectivity, albedo, or skin tone of surfaces in the frame that are derived from depth values captured from the surfaces. Other technical features may be readily apparent to one skilled in the art from the following figures, descriptions, and claims.
Aspect 5: The method of any one of Aspects 1-4 may also include detecting that a region including the at least one of the aligned features is clipped in the frame captured using flash lighting, and recovering a detail of the at least one of the aligned features from the frame captured under ambient lighting for inclusion in the frame captured using flash lighting. Other technical features may be readily apparent to one skilled in the art from the following figures, descriptions, and claims.
Aspect 6: The method of any one of Aspects 1-5 may also include where the detecting that a region including at least one of the aligned features is clipped in the frame captured using flash lighting comprises determining that a greater than an upper threshold portion of pixels making up at least one of the aligned features is above a valid brightness range. Other technical features may be readily apparent to one skilled in the art from the following figures, descriptions, and claims.
Aspect 7: The method of any one of Aspects 1-6 may also include recovering detail of the at least one of the aligned features from the frame captured under ambient lighting for inclusion in the color-consistent frame using a detail transfer process, where the detail transfer process includes generating a mask identifying the aligned features that are clipped or subject to matt haze for which detail is to be recovered from the frame captured using flash lighting, using the mask to guide the detail transfer process to combine levels of a real-time pyramidal decomposition of the frame captured under ambient lighting and frame captured using flash lighting. Other technical features may be readily apparent to one skilled in the art from the following figures, descriptions, and claims.
Aspect 8: The method of any one of Aspects 1-7 may also include where the detail transfer process utilizes different techniques for the high resolution portions of the image and the low resolution portion of the pyramidal decomposition of the frame captured under ambient lighting and frame captured using flash lighting, the method comprising performing a difference of Gaussian pyramid fusion technique to transfer high frequency and high resolution aspects of the at least one of the aligned features from the frame captured under ambient lighting into the frame captured using flash lighting, and performing a gradient domain transfer using a Fast Fourier Transform for low frequency aspects of the at least one aligned feature from the frame captured under ambient lighting into the frame captured using flash lighting.
Aspect 9: The method of any one of Aspects 1-8 may also include outputting a visual confidence map that indicates portions of the color-consistent frame that have accurate colors and portions of the color-consistent frame that have plausible but possibly not accurate colors.
Aspect 10: The method of any one of Aspects 1-9 may also include generating, by the image signal processor, a thumbnail version of the frame captured under ambient lighting and the thumbnail version of the frame captured using flash lighting, where the thumbnail version of the frame captured under ambient lighting and the thumbnail version of the frame captured using flash lighting are used in the global registration, and the calculating the contribution of the ambient lighting to the at least one of the aligned features in the frame captured using flash lighting and a contribution of the strobe lighting to the at least one of the aligned features in the frame captured using flash lighting.
Aspect 11: The method of any one of Aspects 1-10 may also include decomposing, by the image signal processor, the thumbnail version of the frame captured under ambient lighting and the thumbnail version of the frame captured using flash lighting to yield decomposed thumbnail version of the frame substantially illuminated with strobe-only lighting.
Aspect 12: The method of any one of Aspects 1-11 may also include determining a confidence value for the contribution of the strobe lighting to the at least one of the aligned features in the frame captured using flash lighting, when the confidence value for the contribution of the strobe lighting to the at least one of the aligned features is above a threshold performing the adjusting the at least one of the aligned features in the frame captured using flash lighting to yield the at least one of the aligned features illuminated using the strobe lighting and substantially without the ambient lighting.
Aspect 13: The method of any one of Aspects 1-12 may also include determining that the frame captured using flash lighting includes the at least one of the aligned features that are clipped or subject to matt haze, the determining includes detecting that a region including the at least one of the aligned features includes a proportion of pixels above a threshold brightness range, which indicates that the at least one of the aligned features may be clipped or subject to matt haze, where when the proportion of the pixels is above an upper threshold the at least one of the aligned features are considered to be clipped, where when the proportion of the pixels is above a threshold brightness range but less than the upper threshold proportion of the pixels the aligned features may be subject to matt haze.
Aspect 14: The method of any one of Aspects 1-13 may also include wherein clipped refers to a condition where the intensity of the light from the strobe exceeds the dynamic range of the camera sensor resulting in areas of the photograph that are overexposed to the point of losing significant detail. The method for determining may also include where matt haze refers to a non-uniform reflection effect that scatters light, causing portions of the at least one of the aligned features to be above a valid brightness range.
Aspect 15: The method of any one of Aspects 1-14 may also include when the at least of of the aligned features is clipped or subject to matt haze, recovering a detail of the at least one of the aligned features from the frame captured under ambient lighting using a detail transfer process, where the detail transfer process includes performing a difference of Gaussian pyramid fusion technique to transfer high frequency aspects of the at least one aligned feature from the frame captured under ambient lighting into the color-consistent frame, and performing a gradient domain transfer using a Fast Fourier Transform for low frequency aspects of the at least one aligned feature from the frame captured under ambient lighting into the color-consistent frame.
Aspect 16: The method of any one of Aspects 1-15 may also include when it is determined that the at least one of the aligned features may be subject to matt haze, performing a matt haze detection method includes constructing a weight map from a thumbnail version of the frame captured under ambient lighting and a clipping mask of the frame captured using flash lighting, wherein the weight map is used to exclude known clipped and near clipped regions from a gain transform.
Aspect 17: The method of any one of Aspects 1-16 may also include calculating an intensity image from the thumbnail version of the frame captured under ambient lighting and from a coarse version of the frame captured using flash lighting, wherein in the intensity image pixels carry a value indicative of a certain amount of light intensity; the pixel values in an intensity image typically range from 0 to 255 for 8-bit images, where 0 represents black (no intensity), 255 denotes white (full intensity), and the values in between correspond to various shades of gray.
Aspect 18: The method of any one of Aspects 1-17 may also include calculating a weighted intensity gain transform with intensity bands to transform the intensities of the frame captured under ambient lighting to the intensities of the coarse version of the frame captured using flash lighting using spatial and intensity weightings normalizing the intensity image from a thumbnail version of the frame captured under ambient lighting the frame captured using flash lighting, wherein the normalizing is performed to be able to measure small positive variations in a low frequency range of the frame, which characterizes changes in intensity over spatial regions within the image, wherein the coarse version of the frame captured using flash lighting refers to an initial, rough representation or structure, characterized by a lower resolution or less detailed overview compared to subsequent, more refined representations. The coarse frame serves as the preliminary frame in multi-stage processing or analysis pipelines. This preliminary frame may capture essential spatial, temporal, or structural information, from which finer, more detailed frames are subsequently derived or against which they are refined, constructing a low resolution gain map by applying the gain transform to the coarse version of the frame captured using flash lighting, where the low resolution gain map excludes high frequency detail.
Aspect 19: The method of any one of Aspects 1-18 may also include calculating a weighted intensity gain transform with intensity bands to transform the intensities of the frame captured under ambient lighting to the intensities of the coarse version of the frame captured using flash lighting using spatial and intensity weightings classifying the at least one of the aligned features as being subject to matt haze or not by a plurality of classifiers, where the plurality of classifiers include a shadow detection classifier that detects shadow edges by finding regions with strong gradient changes in the intensity gain map, a quality of ambient content classifier that detects large gain changes between ambient and flash indicates more noise, a first white dot region classifier that finds regions with positive brightness changes, a second white dot region classifier that finding regions with stronger image gradients in the ambient frame, constructing a matt haze fusion mask from outputs from the plurality of classifiers, where the fusion mask limits transfer of poor quality ambient regions, forces max correction on flash clipped regions, removes clipping correction on ambient clipped regions, and limits transfer on shadow edges, and diffusing the fusion mask to ensure smooth transitions.

Other technical features may be readily apparent to one skilled in the art from the following figures, descriptions, and claims.

What is claimed is:

1. A method comprising:
receiving, by an image signal processor, a frame captured under ambient lighting and a frame captured using flash lighting;
performing, by the image signal processor, a global registration comparing the frame captured under ambient lighting with the frame captured using flash lighting to yield aligned features present in the frame captured under ambient lighting and the frame captured using flash lighting;
calculating, by the image signal processor, based on a comparison of the frame captured under ambient lighting with the frame captured using flash lighting and at least one known characteristic of strobe lighting in the frame captured using flash lighting, a contribution of the ambient lighting to the at least one of the aligned features in the frame captured using flash lighting and a contribution of the strobe lighting to the at least one of the aligned features in the frame captured using flash lighting;
adjusting, by the image signal processor, the at least one of the aligned features in the frame captured using flash lighting to yield a frame substantially illuminated with strobe-only lighting based on the calculated contribution of the ambient lighting and the contribution of the strobe lighting; and
rendering, by the image signal processor, the at least one of the aligned features illuminated using the strobe lighting and substantially without the ambient lighting in a color-consistent frame.

2. The method of claim 1, further comprising:
generating the color-consistent frame using an outlier-resilient style transfer algorithm to process the frame substantially illuminated with strobe-only lighting to create a high-fidelity full-resolution color constancy output that is the color-consistent frame.

3. The method of claim 1, further comprising:
prior to capturing the frame captured under ambient lighting, determining, by an auto exposure algorithm, one or more ambient frame exposure parameters to result in the frame captured under ambient lighting that is optimized for accurate decomposition; and
prior to capturing the frame captured using flash lighting, determining, by the auto exposure algorithm, one or more strobe frame exposure parameters and/or a strobe profile that is predicted to result in the frame captured using flash lighting that is optimized for accurate decomposition.

4. The method of claim 3, wherein the one or more strobe frame exposure parameters and/or a strobe profile are determined based on an estimate of reflectivity, albedo, or skin tone of surfaces in the frame that are derived from depth values captured from the surfaces.

5. The method of claim 1, further comprising:
recovering detail of the at least one of the aligned features from the frame captured under ambient lighting for inclusion in the color-consistent frame using a detail transfer process, wherein the detail transfer process includes:
generating a mask identifying the aligned features that are clipped or subject to matt haze for which detail is to be recovered from the frame captured using flash lighting; and
using the mask to guide the detail transfer process to combine levels of a real-time pyramidal decomposition of the frame captured under ambient lighting and frame captured using flash lighting.

6. The method of claim 5, wherein the detail transfer process utilizes different techniques for high resolution portions of the image and low resolution portions of the pyramidal decomposition of the frame captured under ambient lighting and frame captured using flash lighting, the method comprising:
performing a difference of Gaussian pyramid fusion technique to transfer high frequency and high resolution aspects of the at least one of the aligned features from the frame captured under ambient lighting into the frame captured using flash lighting; and
performing a gradient domain transfer using a Fast Fourier Transform for low frequency aspects of the at least one aligned feature from the frame captured under ambient lighting into the frame captured using flash lighting.

7. The method of claim 1 further comprising:
outputting a visual confidence map that indicates portions of the color-consistent frame that have accurate colors and portions of the color-consistent frame that have plausible but possibly not accurate colors.

8. The method of claim 1, comprising:
determining that the frame captured using flash lighting includes the at least one of the aligned features that are clipped or subject to matt haze,
when the at least of of the aligned features is clipped or subject to matt haze, recovering a detail of the at least one of the aligned features from the frame captured under ambient lighting using a detail transfer process,
wherein the detail transfer process includes performing a difference of Gaussian pyramid fusion technique to transfer high frequency aspects of the at least one aligned feature from the frame captured under ambient lighting into the color-consistent frame, and performing a gradient domain transfer using a Fast Fourier Transform for low frequency aspects of the at least one aligned feature from the frame captured under ambient lighting into the color-consistent frame.

9. The method of claim 1, comprising:
determining that the frame captured using flash lighting includes the at least one of the aligned features are subject to matt haze;
constructing a weight map from a thumbnail version of the frame captured under ambient lighting and a clipping mask of the frame captured using flash lighting;
calculating an intensity image from the thumbnail version of the frame captured under ambient lighting and from a coarse version of the frame captured using flash lighting;
calculating a weighted intensity gain transform with intensity bands to transform the intensities of the frame captured under ambient lighting to the intensities of the coarse version of the frame captured using flash lighting using spatial and intensity weightings:
normalizing the intensity image from a thumbnail version of the frame captured under ambient lighting the frame captured using flash lighting;
constructing a low resolution gain map by applying the gain transform to the coarse version of the frame captured using flash lighting, wherein the low resolution gain map excludes high frequency detail; and
classifying the at least one of the aligned features as being subject to matt haze or not by a plurality of classifiers.

10. A non-transitory computer-readable storage medium, the computer-readable storage medium including instructions that when executed by a computer, cause a chipset to:
receive a frame captured under ambient lighting and a frame captured using flash lighting;
perform a global registration comparing the frame captured under ambient lighting with the frame captured using flash lighting to yield aligned features present in the frame captured under ambient lighting and the frame captured using flash lighting;
calculate based on a comparison of the frame captured under ambient lighting with the frame captured using flash lighting and at least one known characteristic of strobe lighting in the frame captured using flash lighting, a contribution of the ambient lighting to the at least one of the aligned features in the frame captured using flash lighting and a contribution of the strobe lighting to the at least one of the aligned features in the frame captured using flash lighting;
adjust the at least one of the aligned features in the frame captured using flash lighting to yield a frame substantially illuminated with strobe-only lighting based on the calculated contribution of the ambient lighting and the contribution of the strobe lighting; and
render the at least one of the aligned features illuminated using the strobe lighting and substantially without the ambient lighting in a color-consistent frame.

11. The computer-readable storage medium of claim 10, wherein the instructions further configure the chipset to:
generate the color-consistent frame using an outlier-resilient style transfer algorithm to process the frame substantially illuminated with strobe-only lighting to create a high-fidelity full-resolution color constancy output that is the color-consistent frame.

12. The computer-readable storage medium of claim 10, wherein the instructions further configure the chipset to:
recover detail of the at least one of the aligned features from the frame captured under ambient lighting for inclusion in the color-consistent frame using a detail transfer process, wherein the detail transfer process includes:
generate a mask identifying the aligned features that are clipped or subject to matt haze for which detail is to be recovered from the frame captured using flash lighting; and
using the mask to guide the detail transfer process to combine levels of a real-time pyramidal decomposition of the frame captured under ambient lighting and frame captured using flash lighting.

13. The computer-readable storage medium of claim 12, wherein the detail transfer process utilizes different techniques for high resolution portions of the image and low resolution portion of the pyramidal decomposition of the frame captured under ambient lighting and frame captured using flash lighting.

14. The computer-readable storage medium of claim 10 wherein the instructions further configure the chipset to:
output a visual confidence map that indicates portions of the color-consistent frame that have accurate colors and portions of the color-consistent frame that have plausible but possibly not accurate colors.

15. The computer-readable storage medium of claim 10, wherein the instructions further configure the chipset to:
determining that the frame captured using flash lighting includes the at least one of the aligned features that are clipped or subject to matt haze,
when the at least of the aligned features is clipped or subject to matt haze, recover a detail of the at least one of the aligned features from the frame captured under ambient lighting using a detail transfer process,
wherein the detail transfer process includes perform a difference of Gaussian pyramid fusion technique to transfer high frequency aspects of the at least one aligned feature from the frame captured under ambient lighting into the color-consistent frame, and performing a gradient domain transfer using a Fast Fourier Transform for low frequency aspects of the at least one aligned feature from the frame captured under ambient lighting into the color-consistent frame.

16. The computer-readable storage medium of claim 10, when it is determined that the at least one of the aligned features may be subject to matt haze, perform a matt haze detection method comprising:
construct a weight map from a thumbnail version of the frame captured under ambient lighting and a clipping mask of the frame captured using flash lighting;
calculate an intensity image from the thumbnail version of the frame captured under ambient lighting and from a coarse version of the frame captured using flash lighting;
calculate a weighted intensity gain transform with intensity bands to transform the intensities of the frame captured under ambient lighting to the intensities of the coarse version of the frame captured using flash lighting using spatial and intensity weightings:
normalize the intensity image from a thumbnail version of the frame captured under ambient lighting the frame captured using flash lighting;
construct a low resolution gain map by applying the gain transform to the coarse version of the frame captured using flash lighting, wherein the low resolution gain map excludes high frequency detail; and
classify the at least one of the aligned features as being subject to matt haze or not by a plurality of classifiers.

17. A computing system comprising:
at least one processor; and
a memory storing instructions that, when executed by the processor, configure the at least one processor to:
receive a frame captured under ambient lighting and a frame captured using flash lighting;
perform a global registration comparing the frame captured under ambient lighting with the frame captured using flash lighting to yield aligned features present in the frame captured under ambient lighting and the frame captured using flash lighting;
calculate based on a comparison of the frame captured under ambient lighting with the frame captured using flash lighting and at least one known characteristic of strobe lighting in the frame captured using flash lighting, a contribution of the ambient lighting to the at least one of the aligned features in the frame captured using flash lighting and a contribution of the strobe lighting to the at least one of the aligned features in the frame captured using flash lighting;
adjust the at least one of the aligned features in the frame captured using flash lighting to yield a frame substantially illuminated with strobe-only lighting based on the calculated contribution of the ambient lighting and the contribution of the strobe lighting; and
render the at least one of the aligned features illuminated using the strobe lighting and substantially without the ambient lighting in a color-consistent frame.

18. The computing system of claim 17, wherein the instructions further configure the at least one processor to:
generate the color-consistent frame using an outlier-resilient style transfer algorithm to process the frame substantially illuminated with strobe-only lighting to create a high-fidelity full-resolution color constancy output that is the color-consistent frame.

19. The computing system of claim 17, wherein the instructions further configure the at least one processor to:
recover detail of the at least one of the aligned features from the frame captured under ambient lighting for inclusion in the color-consistent frame using a detail transfer process, wherein the detail transfer process includes:
generate a mask identifying the aligned features that are clipped or subject to matt haze for which detail is to be recovered from the frame captured using flash lighting; and
use the mask to guide the detail transfer process to combine levels of a real-time pyramidal decomposition of the frame captured under ambient lighting and frame captured using flash lighting.

20. The computing system of claim 17, wherein the instructions further configure the at least one processor to:
determine that the frame captured using flash lighting includes the at least one of the aligned features are subject to matt haze by using a plurality of classifiers that make independent determinations of the existence of matt haze.
